(19) United States
(12) Patent Application Publication
(10) Pub. No.: US 2014/0230946 A1
(43) Pub. Date: Aug. 21, 2014

(54) THERMAL INSULATING ELEMENT, A SUBSEA STRUCTURE SUCH AS AN ARMOURED UNBONDED FLEXIBLE PIPE COMPRISING SUCH AN ELEMENT, AND METHODS OF MANUFACTURING SUCH AN ELEMENT AND SUCH A PIPE

(71) Applicant: National Oilwell Varco Denmark I/S, Brondby (DK)

(72) Inventors: Inger-Margrete Procida, Hellerup (DK); Allan Boye Hansen, Sandefjord (NO)

(21) Appl. No.: 14/347,350

(22) PCT Filed: Sep. 19, 2012
(86) PCT No.: PCT/DK2012/050348

§ 371 Date: Mar. 26, 2014

(30) Foreign Application Priority Data
Sep. 29, 2011 (DK) PA 2011 00749

(51) Int. Cl. F16L 59/153; B29C 47/00

(52) U.S. Cl. CPC F16L 59/153; B29C 47/0028
USPC 138/129; 138/137; 428/188; 264/209.1

(57) ABSTRACT

The invention relates to a thermal insulating element. The element comprises a base material comprising one first series of hole configurations, said first series comprising a plurality of elongated interior holes. Each comprises a central hole axis (A) along its elongation, each central hole axis extending substantially mutually in parallel to each other along a first longitudinal direction. Each hole in a plane perpendicular to the first general longitudinal direction comprises a cross sectional hole shape. The elastic modulus E of said base material along said first longitudinal direction is equal to or larger than 1.5 GPa. The thermal insulating element is suitable for varying and high pressure environments. Further, the invention relates to armored unbonded flexible pipes comprising such a thermal insulating element. Further, the invention relates to a method of manufacturing such an element and a method of manufacturing such an armored unbonded flexible pipe.

### TECHNICAL FIELD

The present invention concerns a thermal insulating element for varying and high pressure environments, such as subsea structures, e.g. subsea pipes and in particular armoured unbonded flexible pipes for subsea fluid transfer, such as hydrocarbon transfer. The invention also concerns a subsea structure comprising such a thermal insulating element, such as an armoured unbonded flexible pipe. Further, the invention concerns a method of manufacturing such an element and a method of manufacturing such an armoured unbonded flexible pipe.

### BACKGROUND ART

It is well known to thermally insulate subsea structures, such as pipes, valve systems, pump systems, monitoring systems and the like. In many situations it is desired to thermally insulate subsea structures which are adapted to be in contact with fluids such a petrochemical fluids, e.g. crude oil and gas, e.g. during transport of these.

Pipes of the above-mentioned type normally comprise an inner sealing sheath which forms a barrier against the outflow of the fluid which is conveyed through the pipe. The inner sealing sheath may be wound with one or more armor layers which are not chemically bound to the inner sealing sheath but which can move in relation thereto, which ensures the flexibility of the pipe during deployment and operation.

Around the armor layers an outer sheath is provided with the object of forming a barrier against the ingress of fluids from the pipe surroundings to the armor layers. In order to prevent the collapse of the inner sealing sheath, a so-called carcass, i.e. a flexible, wound pipe of e.g. steel is provided on the inner side hereof. The armor layers, which are used as pressure armor, are most often constructed in such a way that they comprise different metallic tapes. When wound with a large angle in relation to the longitudinal axis of the pipe, these tapes will be able to absorb radial forces resulting from outer or inner pressure on the pipe. Among other things the tapes thus prevent the pipe from collapsing or exploding as a result of pressure, and are thus called elongated pressure-resistant armoring tapes or pressure-resistant tapes.

Conversely, the tapes, more specifically the tension resistant armoring tapes, which are wound with a small angle in relation to the longitudinal axis of the pipe, will not be able to absorb radial forces to any significant degree, but on the other hand are able to absorb forces exerted along the longitudinal axis of the pipe. In the following, this type of elongated tape is referred to as elongated tension resistant armoring tapes or tension-resistant tapes.

Together, the tension-resistant tapes and the pressure-resistant tapes form the armor of the pipe. In this armoring layer a free volume of such configuration also exists so that this can be ventilated, whereby a destructive build-up of pressure as a result of diffusion does not arise.

The above-mentioned type of flexible pipes is used, among other things, for the transport of fluids and gases such as hydrocarbons in different depths of water. They are used especially in situations where very high or varying water pressure exists along the longitudinal axis of the pipe. As examples can be mentioned flexible riser pipes which extend from the seabed up to an installation on or near the surface of the sea. Pipes of this type are also used between installations which are located at great depths on the seabed experiencing elevated pressures, or between installations near the surface of the sea being subjected to increased loads e.g. from waves, thugs, or flow.

Transportation of unprocessed well products in pipes often results in difficulties due to a lack of proper control of the temperature within the pipe. If the temperature is too high, the polymer materials of the flexible pipe may degrade and/or corrosion of metal armoring may increase; and if the temperature is too low, a number of undesired effects in the hydro carbon products have been observed including
undesired increases in viscosity which reduces the product flow rate within the pipe;
precipitation of dissolved paraffin and/or flocculation of asphaltenes below dew point/bubble point in the well product which also increases the viscosity of the product, and
which once deposited can reduce the effective inside diameter of the pipe; and
obstruction of the pipe due to sudden, compact, and massive formation of gas hydrates which precipitate at high pressure and low temperature.

A problem in connection with the use of pipes of the type described above is that the transport of heat through the walls of the pipe can be quite considerable. With certain uses this is critical, since this type of pipe is often used to transport fluids, which are desired to be kept or held at a temperature which deviates from that of the surroundings. An example of such a use can be mentioned, e.g. that of transporting crude oil between two installations. If the temperature of the crude oil falls below a certain critical limit, mineral wax and solid hybrids can as mentioned above be formed in the pipe, which results in obstructions in the pipe.

In order to hold the transport of heat through the walls of the pipe at an acceptable level, it is known to seek to avoid some of the undesired effects by using unbonded flexible pipes with thermal insulations, thereby reducing heat loss of fluids flowing in the bore of the pipes e.g. as it is described in U.S. Pat. No. 6,530,137.

The term “insulating” is—unless other is specifically stated—used herein to designate “thermal insulating”, i.e. a means to maintain a gradient of temperature, by providing a region of material in which heat flow is reduced or thermal radiation is reflected rather than absorbed. Insulation performance is characterized by many factors, such as thermal conductivity, λ having an SI-unit of W/m·K—the lower the conductivity, the higher the insulating effect. Another often used insulation parameter is the U-value or overall heat transmission coefficient, which describes how well an element conducts heat from just above 0 and up and have an SI-unit of W/m2·K. It measures the rate of heat transfer through an element over a given area, under standardized conditions, where a small U-value indicates a better insulator. In the following, only the material property thermal conductivity lambda will be used.

WO 2007/085013 describes an insulated subsea pipe comprising a helically wound bendable hollow extrusion of elastomeric material filled with a gelatinous paste, such as glass microspheres in silicone grease.

U.S. Pat. No. 6,530,137 describes a heat-insulated flexible pipe comprising at least one layer of rigid and extruded insulating material on the outside of the pipe. The layer comprises means for restoring the flexibility of the insulated pipe in the form of at least one circumferential slot, positioned at predetermined intervals along the length of the pipe in order to provide the otherwise rigid pipe with at least some flexibility.

U.S. Pat. No. 6,283,160 describes an unbonded flexible pipe being wound helically with an insulating, rigid material, where the windings are provided with an intermediate gap. By co-winding, this gap is filled by a material, such as a hydrocarbon elastomer, which in volume exhibits an incompressible effect and which exhibit liquid filled cavities.

U.S. Pat. No. 6,227,250 describes an unbonded flexible pipe being wound with an insulating, rigid material with a very long pitch and with a lay angle of between 20 and 30 DEG, where the windings are provided with an intermediate gap.

Such slots or gaps in the rigid insulating material may infer the possibility of mechanical instability and the occurrence of cracks alongside it during use. Also, the application of such rigid insulation material is detrimental to the flexibility of e.g. flexible pipes.

Examples of insulating materials which are applied in prior art subsea structures having improved mechanical stability, i.e. improved toughness, includes for example polyketons or polyolefins, such as polypropylene as described in US 2006/0048833.

Other types of insulation materials are used at present, such as e.g. a thermoset or thermoplastic polymer like polyurethane (PU) or polypropylene (PP) foams. However, they tend to exhibit limited life expectancy due to the environment that the pipes are exposed to during e.g. deep sea or high riser applications, i.e. often varying high pressures and temperatures, which induce rapid ageing effects in the insulation material.

Another type of insulation called syntactic foam intends to counteract pressure compaction includes to wind one or more layers of bands made of syntactic foam on the outside of the pipe's tension-resistant armor, but on the inside of the outer sheath. Syntactic foam contains a large amount of hollow, rigid glass or polymer balls or spheres, which have a high resistance against crushing, and a polymeric matrix material. Syntactic foam possesses a low heat transmission coefficient (U-value), whereby the use of this material reduces the transport of heat through the walls of the pipe to an acceptable level.

However, the use of syntactic foam involves a number of limitations, the most important of which is that the mechanical strength of the foam and/or spheres often becomes the factor which limits the areas of application of the pipe, in particular at great sea depths when exposed to varying compression pressures. The syntactic foam possesses a high resistance against hydrostatic crushing, but only limited resistance against deformation and damage by local mechanical influences. A second problem connected with the use of syntactic foam is that the long-term characteristics of this material can be problematic to predict, depending on many factors, such as dimensions, material selection, ageing as mentioned above, and the like.

US 2009/0101225 describes an example of such syntactic foam for flexible pipes, and describes an unbonded flexible pipe body and a method of providing such a flexible pipe. The flexible pipe body includes a fluid retaining layer, at least one tensile armor layer, at least one extruded thermal insulation layer of extruded syntactic foam over an outermost one of the at least one tensile armor layers and an outer shield layer over the insulation layer, wherein the syntactic foam comprises a plurality of glass or plastic micro-spheres.

The trend within subsea structures, such as flexible pipes, shows an ever increasing need for adaption to ever varying pressure regimes, e.g. during use in shallow waters, or when being hoisted up and down between low and increased depths, where the structure is subjected to varying pressures, or when being applied in deeper waters, such as below 500 m under water level, or even approaching deep waters more than 1000 m under water level, such as even 3000 m under water level. Thus, such subsea structure may be subjected to increased hydrostatic pressures or at least varying hydrostatic pressure differences, and a lowering of outside water temperatures when used in deep waters.

Thus, the pipe disclosed in US2009/0101225 has proved effective until a certain time or a certain depth and pressure, where the syntactic foam even with glass microspheres is compacted by the pressure to such an extent in a radial direction that the thermal conductivity λ of the insulation layer actually increases rapidly to that of the glass or plastic microspheres used, due to the fact that the foam matrix at least partly collapses which reduces the thermal insulation effect of the layer.

Thus, industrially, a need exists at present for providing insulating materials for sub-sea structures, which materials exhibit an improved combination of both thermal insulation and mechanical properties, such as bendability and compression strength.

### DISCLOSURE OF INVENTION

An object of the invention is to provide an alternative thermal insulating element which is suitable for use when insulating unbonded flexible pipes, even unbonded flexible pipes which will be subjected to high pressures and/or highly varying pressure differences.

This object has been achieved by the thermal insulating element as defined in the claims and as described herein below.

In an embodiment, there is provided a thermal insulating element having an element length, where said element comprises a base material comprising at least one first series of hole configurations, said first series comprising a plurality of elongated interior holes, each comprising a central hole axis (A) along its elongation, each central hole axis extending substantially mutually in parallel to each other at least along a first longitudinal direction, wherein each hole in a plane perpendicular to the first general longitudinal direction comprises a cross sectional hole shape, and wherein the elastic modulus E of said base material at least along said first longitudinal direction is equal to or larger than 1.5 GPa.

It has been found that by providing an element according to the invention a very beneficial thermal insulating element can be obtained which exhibits a surprisingly beneficial combination of properties compared to prior art insulating elements.

By selecting an appropriate base material and series of hole configurations as claimed, the thermal insulating element may be adapted to provide an axial compression strength which is compatible with the hydrostatic pressure generated by the head of water in which the structure is intended to be laid out, or taken in and out from. Apart from resulting compression strength, the thermal insulating element of the invention can selectively be provided with other improved mechanical properties such as exhibiting and keeping a selected, excellent flexural modulus, i.e. the ratio of stress to strain in flexural deformation at three points, i.e. in the middle of a beam measure as compared to the end thereof as measured in the ISO system test ISO 178 and in the ASTM system test ASTM D790, and at the same time exhibiting relatively low element weight or density. An engineered selectable flexural modulus is an advantage when the element e.g. is used on round and/or flexible subsea structures, such as flexible pipes. An increased flexural modulus means that a large bending force is needed along at least one and in particular more than one direction, and in some element application this is preferred, in other a decreased flexural modulus is preferred, which makes it easier to bend or wind around structures to be insulated.

Another parameter influencing both the resulting compression strength and the flexural modulus of the element is the elastic modulus E, also termed Young's modulus: the higher the E, the lower the elasticity. Young's modulus E describes tensile elasticity, or the tendency of a beam to deform along an axis when opposing forces are applied along that axis; it is defined as the ratio of tensile stress to tensile strain. By selecting a material having an E 1.5 GPa, the resulting compression strength of the element is increased and a selectable flexural modulus can be provided along at least one, preferably along two longitudinal directions or even more directions.

Accordingly, a relatively soft or elastic polymer, such as e.g. an elastomer such as rubber having an E<1.5 GPa, is not suitable due to the fact that when the otherwise non-compressible elastomer material is provided with longitudinal holes, high outside pressures will tend to flatten such element, which again influences negatively upon the thermal insulation property of such flattened element. Even when comprising a fluid, the compressive forces in play e.g. at deeper water will be too great for the fluid to counteract such flattening. Thus, it is an advantage that the base material in it self is selected to be of a less elastic material.

Further, some elastomer surfaces may tend to react negatively to sliding against each other, so when providing e.g. two layers of elastomer elements in contact with each other, the layers will tend to hinder or resist a free slide. This will work against an unhindered movement of element layers against each others and thus hinder the flexibility of e.g. unbonded flexible pipes during use.

Note that Young's modulus E is a material property for the base material itself, not for the element. The E value of the element may be significantly higher or lower, depending on hole configurations used and optionally which core filler has been provided, see below. As the skilled person, e.g. a polymer technician is aware of, the E value of the element may be suitably selected by proper selection of the base material substances.

By the invention, it is now possible to provide a thermal insulating element exhibiting both improved insulating and mechanical properties, even at high pressures. A prior art element comprising syntactic foam exhibits decreased mechanical properties and decreased insulating properties at increased water pressures. A prior art element comprising pure polypropylene also exhibits decreased mechanical properties and decreased insulation properties at increased water pressures, and is further not very bendable during application. By the invention, it has been realized that the element may be engineered by selecting its base material and hole configuration parameters to exhibit exactly the proper mechanical and insulating properties as will be demanded by the application in question.

This thermal insulating element is then suitable for sub sea structures, e.g. for insulating armoured unbonded flexible pipes which may be subjected to varied internal and/or external pressures and/or temperature differences during use, such as e.g. for riser and/or deep sea applications. The need is as mentioned steadily increasing to be able to transport fluids such as carbohydrates from ever deeper sea depths. The element according to the invention provides the possibility for counteracting such varied internal and/or external pressure and/or temperature differences by applying the element in one or more layers to the subsea structure, e.g. an armoured unbonded flexible pipe.

This is due to the fact that such element exhibits improved mechanical strength and thermal insulation in combination. By providing the element according to the invention, there is provided the possibility of designing a thermal insulating element with excellent thermal properties, even when applied in environments where extremely varied or high pressures and temperatures are experienced, e.g. varying more than 100 Pa/60 sec or being applied in pressure regimes as experienced at or below 1000 m below sea level, or above about 10 MPa. By the invention, it has also been realized that other applications than for the subsea may also be envisaged, such as aerospace or even space applications. In preferred embodiments the thermal conductivity lambda of the element is below about 0.2 W/m·K, approx. equal to the lambda of polypropylene, in other preferred embodiments lambda is below about 0.1 W/m·K, and in some applications lambda is even lower, e.g. below about 0.05 W/m·K, low lambda values below about 0.03 or even 0.01 W/m·K may be contemplated, see below.

Providing the element according to the invention further improves the pipe laying process, because the element may be provided without gaps there between. There is no longer a need for providing a two material insulation layer for a flexible pipe. In prior art, there were often gaps provided between otherwise rigid insulating materials and a filling of this gap with otherwise flexible and insulating elastomer. This is no longer needed, as the bendability of the insulating element is improved simultaneously with the fact that the compression strength of the element is improved as well.

The thermal insulating element exhibits an excellent combination of strength and bendability at least along its element length and along varying angles from the first longitudinal direction. The bendability is herein defined as being equal to the inverse of the flexural modulus. The element may be selectively configured to exhibit such excellent bendability. Further, the element may be configured such that the bendability decreases substantially when the bend force is applied in a second longitudinal direction approaching 90 degrees to the first longitudinal direction of the thermal insulating element. Thus, by proper selection of base material and configuration of the elongated holes the resulting element can be engineered to exhibit bendabilities along different element axes, such that it is e.g. easier to wind around flexible pipes or is easier to attach to flat surfaces to be insulated. Further, only a single type of insulating means, i.e. the element of the invention is needed during the manufacturing of the subsea structure or the flexible pipe. This is an improvement in relation to prior art, wherein two different types of insulating means were needed, such as mechanically strong but stiff insulating tapes in combination with interlaced elastic rubber material in a groove between two such insulating bendable tapes, or such as syntactic foam, the foam forming the bendable and insulating material and the beads forming the mechanically strong structure.

Within this application the term “hole” designates a void in a base, wherein the void optionally may be partly or totally filled with a gaseous, liquid, and/or solid core filler material, i.e. it does not need to be empty in order to be a hole. The term “elongated holes” simply means the everyday use of the term, i.e. that in one direction, in the elongation direction, a diameter of the hole is larger than in any other direction. The “central hole axis” denotes the axis of the hole which extends along said elongation direction, where the axis coincides with said larger diameter. The term “interior holes” means that the holes are provided fully within the base material but may penetrate through the base material, e.g. at the hole ends or on any side surface of the element. The holes may be closed holes, interconnected holes and/or one or more holes may be open e.g. with at least one opening to the environment adjacent the thermal insulating element. The term “mutually in parallel to each other” is not intended to also comprise two elongated holes with their axes extending along the same line—instead it means the normal sense of the term, i.e. in parallel to each other along two different lines. Further, the term “substantially” should in this instance be taken to include that the first longitudinal direction need not be linear, but as mentioned below may follow another path, also within normal machining tolerances. The term “substantially” may be omitted, while this fact should be inherently understood. Also, the expression “along a first longitudinal direction of the thermal insulating element” should be interpreted to mean that the elongation direction of the axis of the respective elongated holes extends in parallel to the first longitudinal direction of the thermal insulating element.

It should also be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features, and it may also indicate that the entire term is comprised herein.

The thermal insulating element has an element length, which is herein defined as the longest dimension of the thermal insulating element. When the thermal insulating element is extruded, the element length preferably extends in parallel to the direction of extrusion. When an equilateral element is provided, the element length may be defined according to application, e.g. coinciding with the lay angle theta or pitch of the element upon the subsea structure, or defined as being one of any suitable direction within the element.

Each hole comprises a cross sectional hole shape, where “cross sectional shape” means a shape as seen in the cross sectional cut perpendicular to the elongation direction of the respective hole. Each hole also comprises at least one elongation shape i.e. seen from the element length side.

In an embodiment of the element, said plurality of elongated interior holes comprises at least three holes, such as at least four holes, such as at least five holes, such as at least ten holes, such as at least twenty holes, such as at least fifty holes.

The wider the element, the more holes may be provided. However, it has turned out that providing a certain number of holes or series of hole configurations is an advantage in order to “break” or improve the bendability of the element at least along the width or the x-axis of the element, and a certain “length” of each hole is needed in order to “break” or improve the bendability of the element at least along the length or the y-axis thereof, see e.g. FIG. 2 or 4. Due to the present invention it is now possible to improve the bendability i.e. to lower the flexural modulus of the element, and thereby the resulting element is easier to design and apply during production. Also, the element exhibits the necessary industrial properties as mentioned above. It has surprisingly been found that by providing at least three, or a plurality, e.g. one or more—preferably parallel—elongated holes, e.g. all provided in a common plane (in side-by-side relation), the strength, stability, low weight, thermal properties, and bendability such as flexural modulus of the resulting element all improve. The resulting thermal insulating element at the same time provides the basis for improving the strength and thermal insulation properties when further provided with a core filler as it will be further described below.

In an embodiment of the element at least said at least one first series of hole configurations extends in the same series directions, however, it does not necessarily have to extend in a flat plane. Thus, it is possible to manufacture different element according to the intended application, provided with the elongated holes extending substantially within the element, in order to provide the bendability needed for that specific element.

In an embodiment of the element, each of said holes have a hole length along said central hole axis of at least about 2 mm, such as at least about 5 mm, such as at least about 1 cm, such as at least about 2 cm, such as at least about 5 cm, such as at least about 10 cm, such as at least about 20 cm, such as at least about 50 cm, such as at least about 1 m, such as at least about 10 m, such as equal to the entire length of the element i.e. continuously. How to select the hole length along the elongation direction of each hole of each element or element section depends on the element application. Thus, the mechanical properties of bendability and compression strength can be engineered by proper selection of element length, thickness and width, base material used, whether or not a core filler and which type of core filler is going to be filled into said hole, working temperature, gas permeability of the base material, distance between the edge of each cross sectional hole shape and the surfaces of the element, such as a bottom or top surface of the element, and many of the other configuration parameters which are mentioned below.

The hole length is one example of a configuration parameter, which may be used. Short hole lengths around less than 5 mm may e.g. be an advantage in short elements or in elements wherein a core filler material is filled in during extrusion. Medium hole lengths between about 5 mm to 5 cm may be an advantage when extruding base materials having intermediate Young's modulus values, such as between about 2 GPa and 5 GPa, or when extruding elements with varying parameters over a section of length. Longer hole lengths, such as more than about 5 cm to about 1 m, or even longer, may be an advantage for example when extruding elements continuously, which elements have non-varying hole configurations, base materials and constant width and thickness. Along the axis of the hole along the elongation length the hole has an elongation shape. This shape may be shaped differently, e.g. banana shaped, oblong oval, rectangular, helix or screw formed, and may depend on which cross sectional hole shape is used.

In an embodiment of the element, a maximal length of an inner diagonal of at least one of the cross sectional hole shapes is equal to or larger than the minimal distance between said cross sectional hole shape and another adjacent cross sectional hole shape, i.e. the minimal distance between the hole in question and an adjacent hole, wherein the hole in question and the adjacent hole may be part of the same at least one series of hole configurations. I.e. the minimum distance (or wall thickness) between the hole in question and a second adjacent hole, such as the nearest adjacent hole, is equal to or smaller than the diameter of at least one of said adjacent holes. The cross sectional hole shape is the hole shape in a cross sectional plane perpendicular to the elongation direction or central hole axis. The minimal distance between such two adjacent holes is determined in the same cross sectional plane, which may or may not coincide with the cross sectional plane.

Thus, by properly selecting this further hole configuration parameter, i.e. the maximum diagonal/minimal sidewall ratio of the two holes in question, the holes may be provided in such a way that it allows for selecting a relatively rigid, but relatively mechanically stable base material, such as polypropylene, and for selecting hole configurations, diameters, lengths or sizes in such a way that the resulting bendability and durability of the element increases, while at the same time decreasing the thermal conductivity and the element total weight. The maximal diagonal of a cross sectional hole shape is the length where it is at its maximum, such as the diameter of a circle or the longest diameter of an oval. When e.g. the maximum diagonal is selected to be equal to the minimum distance between two such hole shapes, further bendability and lightness of the element is provided as compared to the solidly provided base material. When the maximum diagonal is larger than the distance between two holes, improved ease of filling core filler is provided, as well as the possibility and ease of inserting e.g. a non-compressible or phase changing material into the hole is achieved.

Further, the distance/diagonal ratio of the element is selectable relative to the intended use and thus durability and strength of the selected base material.

Such maximal size of a diagonal of the cross sectional hole shape of the at least one hole may lie in the range of about 0.09 mm to about 99.99 mm, such as from about 0.9 mm to about 9 mm, such as from about 1 mm to about 6 mm, from about 2 mm to about 4 mm. Also, the maximal diagonal may advantageously be directly correlated to the thickness and/or width of the resulting element, such as between about 5% to about 99.9% thereof, or between about 10% to about 99%, or between about 40% to 90%, or between about 50% to about 89%, depending on the base material and intended use.

In an embodiment of the element a part of or the whole of the base material exhibits a thermal conductivity of about 0.3 W/m·K or less, such as about 0.25 W/m·K or less, such as about 0.2 W/m·K or less, such as about 0.15 W/m·K or less, such as below 0.10 W/m·K. Today, many such base materials exhibiting suitable thermal conductivity values are available, and any suitable base material for the specific use may be applied. If a relatively high thermal conductivity base material is selected e.g. for strength reasons or low permeability reasons, the element thermal conductivity can be reduced by appropriate selection of hole shape size and e.g. using a suitable low thermal conductivity core filler instead, and vice versa.

In an embodiment of the element according to the invention a part or the whole of the base material is a resin such as a polymer or a polymeric mixture, preferably an extrudable polymer. In embodiments, a part of or the whole of the polymer or polymeric mixture is a homopolymer or a copolymer comprising at least one of the materials in the group comprising polyolefins, e.g. polyethylene or polypropylene (PP), such as stiff linear copolymer PP with a branched homopolymer PP; polyoxyethylenes (POE); cycloolefin copolymers (COC); polyamides (PA), e.g. polyamide-imide, polyamide-11 (PA-11), polyamide-12 (PA-12) or polyamide-6 (PA-6)); polyimide (PI); polyurethanes such as polyurethane-isocyanurate; polyureas; polyesters; polyacetals; polyetherssuch as polyether sulphone (PES); polyoxides; polysulfides, such as polyphenylene sulphide (PPS); thermoplastic elastomers, such as styrene block copolymers, such as poly(styrene-block-butadiene-block-styrene) (SBS) or their selectively hydrogenated versions SEBS and SEPS; termoplastic polyolefins (TPO) e.g. comprising SEBS and/or SEPS; polysulphones, e.g. polyarylsulphone (PAS); polyacrylates; polyethylene terephthalates (PET); polyether-ether-ketones (PEEK); polyvinyls; polyacrylonitrils (PAN); polyetherketoneketone (PEKK); copolymers of the preceding; fluorous polymers e.g. polyvinylidene difluoride (PVDF), homopolymers or copolymers of vinylidene fluoride (“VF2”), homopolymers or copolymers of trifluoroethylene (“VF3”), copolymers or terpolymers comprising two or more different members selected from VF2, VF3, chlorotrifluoroethylene, tetrafluoroethylene, hexafluoropropene, or hexafluoroethylene; compounds comprising one or more of the above mentioned polymers, and composite materials, such as a polymer e.g. one of the above mentioned polymers compounded with reinforcement such as solid or hollow microspheres, e.g. made from glass, polymer or silica, and/or fibres, such as glass fibres, carbon fibres, aramide fibres, silica fibres such as basalt fibres, steel fibres, polyethylene fibres, polypropylene fibres, mineral fibres, and/or any combination thereof. As it is known to the skilled person, the resin may be added various strength enhancing filler materials, additives, activators, lubricants, plasticizers, complexing agents, processing aids, compatibilizing agents and the like.

Again, the choice of resin or polymer for the base material depends on the final application intended for said element.

An oil well delivers a fluid, which consists substantially of hydrocarbons and CO2. In that the oil in the well has a high temperature e.g. of 120° C. or higher, polyvinylidenedifluoride (PVDF) may be selected for the inner sealing sheath of a flexible pipe, given that PVDF is particularly suitable for use at high temperatures and has a very low permeability to CO2. However, the inner sealing sheath cannot safeguard against a too severe cooling of the oil, and for this reason one or more layers of the element according to the invention e.g. comprising as base material polypropylene (PP), are extruded around the inner sealing sheath, said element layers denoted 10 on FIG. 17. In that PP has much poorer barrier characteristics against CO2 than PVDF does, a destructive build-up of pressure will not arise in the interface layer. At the same time, the element layer ensures that the thermal transport of heat between the inside of the pipe and the armor layer is held at an acceptable level.

Thus, PVDF may be preferred also as element base material in environments where a low diffusivity is preferred, e.g. when transporting abrasive gases or liquids, at high or varying temperatures, and/or at high or varying pressures, or where other materials tend to age rapidly. Polyurethane-isocyanurate as base material may be preferred in areas where a light-weight base material with excellent low thermal conductivity is to be applied. Combinations thereof are also contemplated, as well as using composite materials, reinforcements, and the like.

The skilled person is given a wide palette of the above polymer materials to provide a thermal insulating element according to the invention, suitable according to the application of the thermal insulating element. The resulting thermal insulating element is in particular suitable for resisting compressive forces, as experienced in riser pipes and in deep sea applications. The plastic materials as listed above exhibit both increased tensile and torsion strengths, as well as high bulk moduli. Further base material parameters of relevance to the strength and toughness of the element are hardness and brittleness, as well as viscosity, viscoelasticity, and durability against water, temperatures, ageing and the like, however, these are selectable according to the material or combination of materials and presumed known to the skilled person.

Preferably, a part of or the whole of the base material is a material exhibiting a high bulk modulus and high mechanical strength, i.e. strong and tough, at least in e.g. a plane perpendicular to the element length.

Also, a thermal insulating element is provided which is suitable for e.g. an unbonded flexible pipe for primarily hydrocarbon transport, as it is bendable in a longitudinal direction of the structure, and mechanically exhibits a high compressible strength in the axial direction thereof. Furthermore, it is more resistant against ageing effects from the environment, such as high or low temperatures, varying or consistently high pressures, and liquids such as sea water. High compression strength is compatible with increased or varying hydrostatic pressures which the thermal insulating element can be subjected to in use for insulating a sub sea pipe or other structure.

Thermal insulating elements according to the invention of a polymer base material have also shown at the same time to exhibit low thermal conductivity, i.e. a lambda value around or less than about 0.2 W/m·K. The combination of low thermal conductivity and high mechanical strength makes the thermal insulating element extremely useful for insulating unbonded flexible pipe for subsea applications, e.g. deep sea applications. Further, a competitive material cost and eased manufacturing and handling is also achieved when using such polymer base material.

In an embodiment of the thermal insulating element according to the invention a part or the whole of the base material comprises a polyolefin, preferably of a polypropylene-like type, the base material in itself exhibiting a high bulk modulus above 2.2 GPa and a thermal conductivity of below about 0.2 W/m·K.

PP may be preferred as base material due to its provision of excellent mechanical strength and good thermal insulation properties. PP may be preferred in e.g. unbonded flexible pipes, for riser or deep sea applications, also due to low diffusion properties and low density.

In an embodiment of the element according to the invention at least one element surface is smoothened, i.e. levelled flat and easy to slide. This is an advantage when the element is being utilized on e.g. unbonded flexible pipes, both when provided in one layer thereon, such that it easily slides relative to and along the surface of the inner sheath and/or the armour layer, and also when elements are provided in more than one layer, each element layer thus being slidable relative to and upon each other. The smooth surface may be a base material property and/or it may be provided during and/or after extrusion of said element.

In an embodiment of the element according to the invention the element has a width and a thickness perpendicular to each other and to the element length, wherein the width is from about 10 mm to about 20 cm. In an embodiment of the element according to the invention the element has a width and a thickness perpendicular to each other and to the element length, wherein the thickness is from about 0.1 mm to about 10 cm.

The thermal insulating element has a thickness which is perpendicular to the element length of the thermal insulating element and indicates the insulation thickness of the thermal insulating element, i.e. the thickness direction will be normal to the structure which the thermal insulating element is supposed to insulate. The thickness may extend in the Y-axis of the element.

The thermal insulating element has a width which is perpendicular to the element length of the thermal insulating element and to the thickness thereof. The width may extend along an X-axis of the element.

The width of the element may also lie in the range from about 1 mm to 5000 mm, such as from about 10 mm to about 200 mm, such as from about 20 mm to about 150 mm, such as from about 30 mm to about 100 mm. Width and porosity and base material may be selected according to desire and application. When applied to an unbonded flexible pipe, suitable widths may be from about 200 mm to 1200 mm. Tubular elements or parts of tubular, e.g. cylindrical elements are also within the scope of the invention, the widths being here defined as the exterior radius of such tubular element. Other widths may of course also be contemplated, but tend to be less practical to manufacture or to apply to structures which are to be insulated. Further, varying widths may also be contemplated, e.g. for non-linear subsea structures to be insulated.

The thickness of the thermal insulating element is obviously entirely selectable according to application, e.g. unbonded flexible pipes, fixed structures, etc. It may, however, also be correlated to desired bendability, desired application, i.e. pressures and temperatures to be used at, and desired strength. The thickness of the thermal insulating element may lie in the range from about 0.1 mm to 100 mm, such as from about 1 mm to about 10 mm, such as from about 2 mm to about 7 mm, when being applicable to e.g. unbonded flexible pipes. However, thicknesses in the range of about 0.01 mm to about 1000 mm are also conceivable, e.g. if other uses for such elements are contemplated, such as e.g. for aeronautical, space or deep sea exploration uses, in industrial processes under pressure and heat or cold, or the like. Further, of course, elements of varying thicknesses can also be contemplated.

In an embodiment the thickness of the element is at least 10 times shorter than the element length. Thus, the resulting element may be provided with a bendability and durability suitable for e.g. a helical winding around an unbonded flexible pipe.

The length of the thermal insulating element, i.e. the element length may in principle be endless or infinite, these latter terms covering as long as desired, e.g. by extruding continuously, by bonding or laying together two or more such element along a length direction thereof, or in fact as long as it is possible to extrude and handle on site, e.g. by winding helically or plainly around a subsea structure. In an embodiment the thermal insulating element has a length of at least about 5 m. In an embodiment the thermal insulating element has a length of at least about 50 m. In an embodiment the thermal insulating element has a length of at least about 100 m. In an embodiment, the element length may be infinite, where infinite in this application is of course finite, but designates the possibility of either 1) any number of finite length elements may be bonded to or at least contacting each other along one or more sides, e.g. an end surface thereof, forming an elongated element band or element plate or 2) one single extruded element is provided, wherein the length of the element increases continuously during production, where the total length of the element is at least 100 times its width. The element length tends in general to extend along a Z-axis of the element. In an embodiment the thermal insulating element has an element length of at least about 5 times its maximal width, such as at least about 10 times its maximal width.

The element length of the thermal insulating element may further extend in either a flat or bent plane, comprising the Z-axis of the thermal insulating element.

In an embodiment of said element at least one of said holes is entirely encompassed within the element whereby the hole is a non-through hole entirely surrounded by base material. Such non-through hole or closed in hole may be filled with a core filler, see below, and may then be integrally provided without liquid contact to any other elongated hole or the outside environment. An embodiment of said element comprises at least one through hole forming a path through the base material from one distal hole end to one proximal hole end. Such through-hole may connect one element section with another, or may provide a material contact between any such two elements in line with each other, e.g. for transporting or for filling in core filler.

In an embodiment of said element the thermal insulating element comprises at least one through hole forming a path through the base material from one distal hole end to one proximal hole end. Such through hole may extend along any direction, i.e. along any vector extending in the X-, Y- and Z-axis space of the element, i.e. from any element surface to the same or any other element surface. This embodiment also allow for a subsequent filling process into said path, e.g. with a liquid core filler, into the elongated hole or holes.

In an embodiment of the element according to the invention a plurality, such as a majority, such as all of the holes in at least said at least one series of hole configurations, extends substantially mutually in parallel to each other. Thus, at least a section of the element length is provided with a series of a plurality of mutually parallel elongated interior holes, such that a flexural modulus by the total number of holes plus base material can be provided with a selected value. If the holes extend mutually parallel along a first longitudinal direction e.g. for one group of holes in the same hole configuration, but there is also provided a second group or even further group or groups of mutually parallel holes along one or more further longitudinal directions (e.g. different from the Y-axis), then the flexural modulus along said sub groups may vary. This would be the intention in order to provide different flexibilities or bendabilities over the area of the element which stretches along the X-axis and Y-axis. A uniform distribution along the same hole configuration may also be an advantage, e.g. for easing extrusion manufacturing, or for easy calculation of the final element properties.

In an embodiment of the element according to the invention the element comprises an inhomogenous distribution of number and/or sizes and/or cross sectional hole shapes of holes in at least one length section of said element. An embodiment of the element according to the invention comprises a homogeneous distribution of number and/or sizes and/or cross sectional hole shapes of holes in at least one length section of said element. A freely selectable either inhomogeneous or homogeneous distribution of these parameters further enhances the possibility of designing an element with specific properties for the application at hand. By the term “length section” is meant a length subdivision of said element length, such as e.g. 1/10 of the total length of the element. However, a part or the whole of the thickness and/or the width of the element may also be included in such section.

In an embodiment of the element according to the invention the number of holes and/or sizes of holes decreases and/or the cross sectional hole shape changes from one length section of the thermal insulating element to another adjacent length section of the thermal insulating element. Again, this provides another possibility for designing an element with specific properties for the application at hand. Further, a varying amount of core filler, see below, may then be provided along a selected length of the hole, and thus the selectability by using suitable and different hole configurations is increased. Accordingly, the number and/or sizes and/or shape of holes can be arranged such that the insulating properties along its length vary from one section of the thermal insulating element to another section thereof. An advantage of the element is that it can be used with e.g. flexible pipes having a length intended to be used in a permanent position in a subsea environment, wherein the temperature and/or pressure varies along the length of the pipe, such as e.g. risers and the like. This provides for a very useful adaptability of the element such that different insulating properties and strength properties of the thermal insulating element used easily can be provided along the length of e.g. a riser pipe, depending on which temperature and/or pressures that particular length of pipe is intended for. Thus, a single infinite thermal insulating element may be extruded on site and wound directly upon the pipe, without having to change element type at any time during winding. This reduces production and laying times significantly.

In an embodiment of the element according to the invention the first longitudinal direction is coincident with the element length of the thermal insulating element. In another embodiment of the element according to the invention the first longitudinal direction is not coincident with the element length of the thermal insulating element, forming an angle alpha therebetween, such as about 45 degrees or less, preferably about 30 degrees or less, more preferably about 10 degrees or less.

Depending on application, a thermal insulating element according to the invention should preferably be easy both to extrude and easy to apply to the structure, which is to be thermally insulated and protected against compressive forces. Thus, different types of available elements are required for satisfying the different needs in the market. Thus, for example, a flexible pipe may be wound radially instead of helically, while keeping the first longitudinal direction helically wound around it, and thus maintain a given flexibility along a bend of the pipe during use. Thus, a pipe can be designed individually for a specific maximum bending radius during use. Note that the angle alpha is a relative angle, i.e. the element length may also lie perpendicular to the first longitudinal direction of the plurality of elongated holes.

In an embodiment of the element according to the invention said at least one series of hole configurations comprises at least one line of at least two successive non-through holes in line with each other. In another embodiment, at least some, at least a plurality, at least a majority, or all of the holes of said at least one series of hole configurations of successive non-through holes in line with each other are of equal length at least in one length section thereof. In a further embodiment, at least one line of said successive non-through holes in line is displaced in the common longitudinal direction of said holes in relation to another adjacent line of successive non-through holes in line. Such non-through holes are elongated interior holes, wherein at least one distal or proximal hole end thereof is closed, or wherein said hole is entirely encompassed by base material. Any gasses or core filler material which is left in the entirely closed hole during manufacture, e.g. intentionally, is thus trapped within the closed holes without liquid contact to any other hole, and no leaking may be found. Thus, an increased buoyancy of the element can be achieved. This may also improve the mechanical strength, compressibility, and durability of the element. The closed holes may be longitudinally displaced e.g. in pairs or in groups, with respect to each other, whereby a further configuration parameter is provided.

In an embodiment of the element according to the invention said plurality of holes forms a repeating pattern along the first longitudinal direction of the thermal insulating element at least in one length section thereof. This may ease the production process and provide easy calculation of the resulting element properties.

An embodiment of the element comprises at least one further series of hole configurations comprising a plurality of elongated interior holes, having central hole axes along their elongation and extending mutually in parallel along a further longitudinal direction, which is different from the first longitudinal direction, and extends with an angle beta to the first longitudinal direction, beta lying between 0 degrees and 90 degrees.

The further series of hole configurations may comprise two, a plurality, and/or all of the elongated interior holes, extending in the first longitudinal direction either in full fluid connection or without fluid connection some, or all of these elongated holes along the first longitudinal direction. Further elongated holes along a third, a fourth, an N-th further longitudinal direction are also conceivable. Such provision of a multitude of hole rows above (or below) each other provides for another parameter of hole configurations for designing desired properties of the resulting element.

Another embodiment of the element according to the invention comprises at least one further series of hole configurations comprising a plurality of elongated interior holes having central hole axes along their elongation extending mutually in parallel along a further longitudinal direction, which direction is mutually parallel to said first longitudinal direction. This may ease the calculation of resulting element properties by a simpler addition process.

An embodiment of the element according to the invention further comprises one or more connection holes which interconnect two or more of said plurality of elongated, interior holes. In an embodiment of the element according to the invention at least a pair of said elongated, interior holes, a plurality, a majority, or all of the holes in the thermal insulating element are inter-connected with one or more of said connection holes. Such connection holes may be provided in the same extrusion step when the base material is extruded, or they may be provided in a subsequent or further heating and/or processing step in order to provide at least part of the holes of the thermal insulating element with inter-connectivity between them. Such interconnecting of holes makes it simpler to provide the holes with core filler and simultaneously core filler may flow between interconnected holes. Interconnectivity, combined with at least one through hole and using a relatively liquid or gaseous material, all improves ease of filling core during or after manufacturing. Thus, a simultaneous or subsequent filling with core filler may be eased.

Further, when in use, if a compressive pressure is excerted on one part of the element, the interconnectivity of each hole to more holes and thus the liquid or gas connectivity of the core filler enables the progression of compression forces to be distributed evenly throughout the structure, e.g. an unbonded flexible pipe. Further, as mentioned above, this enables a core filler flow through the element or between elements which are bonded or welded together or just contacted by at least one surface thereof. The provision of interconnected groups of holes located in respective sections of the thermal insulating element advantageously provides for the possibility of selectively enabling different core fillers and thus different flows in these respective sections. Accordingly, a gradeable element is provided, such as a strip for an unbonded flexible pipe, which takes into account the different temperatures and pressures, which the unbonded flexible pipe is designed to operate at, at that specific location, where that section is provided. Simultaneously the thermal insulating element may be designed with varying thickness and/or different thermal insulating elements with different base material and/or thickness.

In an embodiment of the element according to the invention the thermal insulating element is a strip, which is substantially flat.

In an embodiment of the element according to the invention at least a pair of said plurality elongated, interior holes extends substantially along a line, such as a linear line, a wave line, a sawtooth line, a zigzag line, and/or any combination thereof, said line extending substantially along said first and/or further longitudinal direction. This hole configuration parameter is selectable according to desire, e.g. to take into account when a number of elements are provided as a multilayer, such as to influence the resulting bendability or other properties. Other line-configurations are possible as is known to the skilled person, as well as combinations thereof, e.g. helix lines in two dimensions, square edge lines, and the like.

The aspect ratio is determined as the length along its elongation direction divided by its maximal dimension perpendicular to its elongation direction, also referred to as its maximal inner diagonal. The aspect ratio is a further configuration parameter to adjust for a designed element. Further, by providing an aspect ratio which is relatively high, such as at least above 2, or even higher, see below, the bendability of the element may be improved, depending on which base material and e.g. core filler is utilized.

In an embodiment the aspect ratio of a plurality, such as the major part of the holes or preferably at least about 90% of the holes is 3 or larger.

In an embodiment the aspect ratio of a plurality, such as the major part of the holes or preferably at least about 90% of the holes is 5 or larger.

In an embodiment the aspect ratio of a plurality, such as the major part of the holes or preferably at least about 90% of the holes is 10 or larger.

In an embodiment the aspect ratio of a plurality, such as the major part of the holes or preferably at least about 90% of the holes is 50 or larger.

In an embodiment the aspect ratio of a plurality, such as the major part of the holes or preferably at least about 90% of the holes is 100 or larger.

In an embodiment of the element according to the invention the central hole axis of each of substantially all of the elongated holes lies substantially in one or more planes to which a thickness axis or Y-axis is normal. In an embodiment of the element according to the invention the central hole axis of each of substantially all of the elongated holes in at least one hole configuration lies substantially in one or more planes to which the thickness axis or Y-axis is not normal. Again, a parameter is provided to be selected for the design of the properties of the resulting element.

In an embodiment of the element according to the invention at least one of said elongated interior holes, such as both, such as a plurality, such as a majority, such as all of the holes are provided with a core filler. In an embodiment of the element according to the invention a part or the whole of the core filler is a gas, a liquid, a solid or any combination thereof. In an embodiment of the element according to the invention a part or the whole of the core filler comprises a semi liquid material selected from the group consisting of grease, gel, bitumen, oil, or any combination thereof. Semi liquid is to here a term to be understood as a description of the consistency of the used core filler, expressed as the viscosity of the core filler material. Semi liquid is then a material having a viscosity between 10 times that of water at 20 degrees Celsius and 10.000 times, i.e. between 10 centipoise and 10.000 centipoise. Said viscosity is equal to the apparent viscosity when the core filler material is non-Newtonian, such as e.g. grease, where the viscosity is determined using the standard ASTM D1092 method. When the core filler is a Newtonian material, such as oil, the viscosity is equal to the kinematic viscosity, which is determined using the standard ASTM D445 method. Bitumen viscosity is determined using the standard ASTM D2170 method. The more liquid a core filler material is, the easier it is to insert after extrusion of the holes.

In an embodiment of the element according to the invention more than 50% of the area of the cross sectional hole shape and/or volume of the hole is filled with core filler, such as more than 75%, such as more than 85%, such as more than 95%, such as more than 97%, preferably more than 99%, such as more than 100%. In the latter case, the base material and/or the core filler material is preferably in itself elastic or compressible, respectively, in order for the hole to house such excess core filler material. Such “pumped” element can exhibit extraordinary properties, as regards to resulting bulk modulus, densities obtainable, thermal insulation property and bendability in all dimensions. Further, the resulting element can be appropriately designed for the specific application in mind. Further, by appropriately selecting core filler/base material and fill degree, different volumes/densities of these two materials as the result of varying pressures/temperatures of the ambience can be taken into account.

This wide selectability of core filler is one of the advantages of the present invention. For example gas core filler such as ambient air, nitrogen, an inactive gas, all provide the element with improved lightness and good thermal properties. Another example is liquids or low viscosity gels such as oils or aerogels, which provide for improved i.e. lower compressibility, in particular e.g. a non-compressible liquid. A solid core filler may be suitable when applied to elements to be used at the pressures present at sub sea levels, such as deep sea levels below 1000 m, even below 3000 m. Here, core fillers may also be suitable for use which core fillers show increased viscosity as the pressures increases and/or the temperatures decreases. Of course, appropriate core filler material and base material may be selected such that they are both chemically and physically compatible. Further, core filler and base material combinations are possible where an advantageous chemical and/or physical interaction between them is intended, e.g. during manufacturing thereof or when encountering specific pressure/temperature regimes.

Where relatively cost-effective, relatively low viscosity core filler materials are utilized, the element may also exhibit improved thermal insulating properties, and the resulting bulk modulus and/or flexural modulus of the element may also improve.

In an embodiment of the element according to the invention a part or the whole of the core filler comprises a phase changing material (PCM). Phase changing materials are characterized in that they can exist in at least two different phases, e.g. an amorphous, i.e. gel or liquid like phase, and one or more crystalline phases, and they can be switched repeatedly between these phases. The different phases can have distinctly different physical properties such as electrical conductivity, optical reflectivity, mass density, or here in particular bulk modulus and/or thermal conductivity. Preferably, during increased pressure and/or decreased exterior temperature and/or increased interior temperatures, the phase-changing material changes to a phase, wherein the thermal insulation property and/or the bulk modulus of the PCM is improved, preferably both.

Examples of these phase changing materials are organic PCM's, such as paraffin (CnH2n+2) and fatty acids (CH3(CH2)2nCOOH), trimethylolethane CH3C(CH2OH)3, and inorganic PCM's, such as salt hydrates (MnH2O), or eutectic PCM's, such as Na2SiO3.5H2O. The phase changing materials may be encapsulated, such as advantageously within the thus provided elongated holes in the elements according to the invention, preferably entirely within the elements, e.g. due to some of these being highly hygroscopic and/or they may be provided as thermal composites. Further, nanoparticles such as e.g. polymer nanoparticles may be present within the phase changing material in order to further decrease thermal conductivity and/or bulk modulus of the phase changing material.

In an embodiment of the element according to the invention a part of or the whole of the core filler comprises a substantially non-compressible material selected from the group consisting of polymers, elastomers, metals, silicates, and silicones, e.g. in the form of a continuous or discontinuous fibre or spheres, such as glass fibres or spheres, rock wool fibres, carbon fibres, aramide fibres, silicate fibres such as basalt fibres, steel fibres, polyethylene fibres, polypropylene fibres, mineral fibres and/or any combination thereof comprising at least one of the foregoing materials. Non-limiting examples of such non-compressible materials include, but not exclusively: Glass, glycerine, glycol, organophosphate esters, polyalphaolefin, propylene glycol, certain mineral oils, greases, waxes, elastomers, butanol, esters e.g. phthalates, like DEHP, and adipates, like bis(2-ethylhexyl) adipate, polyalkylene glycols, glycol-ethers, phosphate esters e.g. tributylphosphate, silicones, alkylated aromatic hydrocarbons, polyalphaolefins e.g. polyisobutenes, silicone oils, silica aerogels, and many of the elements in the periodic table. The holes may comprise through holes or non-through holes filled with such core filler material. It may be an advantage in this way to house or isolate and protect the non-compressible material against the environment, as these materials often exhibit a lower resistance against wear and weather, but also exhibit lower density and higher bulk modulus when encompassed within a confined space.

The bulk modulus K, measured in e.g. GPa, of a material describes the resistance of the material towards uniform compression. It is defined as the pressure increase needed to decrease the volume by a factor of 1/e. For example, material with a bulk modulus value of 35 GPa thus reflects an external pressure of 0.35 GPa to reduce the material volume by one percent. The term non-compressible in this application denotes a material exhibiting an adiabatic K of more than 2.2 GPa, i.e. comparable or higher than the bulk modulus of water at T=20 degrees Celsius.

Both thermal conductivity and bulk modulus may be improved by adding core filler to an element according to the invention. It has surprisingly been found that the combination of holes in a row in a base material with suitable strength and housing capability and suitable core filler provides the element with not only the thermal and bulk modulus properties required for such varying or high pressure/temperature regions, but additionally may also improve and support the bendability needed when e.g. applied to an unbonded flexible pipe.

In an embodiment of the element according to the invention a part or the whole of the base material and/or optionally the core filler comprises a nano-, micro-, meso- and/or macro-porous material or any combination thereof. This means that the material is provided with pores with a diameter around micro scales, i.e. between about 0.2 and about 2 nm, and/or between about 2 and about 50 nm, and/or between about 50 and about 1000 nm. Such material provides for a lighter base material or core filler, often in combination with a lowered thermal conductivity. When elongated holes are provided in such base material, it still renders the possibility of avoiding un-intentional gaseous or liquid contact between any two such elongated holes, if so desired, by proper hole size, form, elongation length, shape, and hole/base material ratio, and so on as mentioned above.

In an embodiment of the element according to the invention a plurality of the cross sectional hole shapes are substantially circular. In another embodiment of the element according to the invention a plurality of cross sectional hole shapes are polygon, such as a triangle, a quadrilateral, such as square, rectangular or rhomboid. The polygon may of course also be triangular, quadrilateral, pentagon, hexagon, heptagon, multigon, polygram, or star-shaped, or any subpart of these, or any combination thereof. Thus, a further configuration parameter is provided for engineering different properties into each element. Sometimes, it may be advantageous to fill out as large an area of said shape respectively as large a volume of the hole with a core filler as possible. Then a polygon shape may be preferred such as a rhomboid, which enables a larger part of the element to be filled with core filler. In other applications, the mechanically more sturdy shape of a circle is more appropriate.

In an embodiment of the element according to the invention the cross sectional hole shape and/or size of the holes and/or an elongation shape of the holes varies along the element length and/or the first and/or further longitudinal direction.

In an embodiment of the element according to the invention the thermal insulating element is shaped with a cross sectional element profile specifically configured for partially contacting and/or overlapping a part or the whole of another such element e.g. when helically wound onto a pipe. The element shape then allows for overlapping between two elements, when positioned on a side and/or a top and/or a bottom surface thereof. This further element configuration parameter may be combined with the other element parameters as desired.

As described above, the element may be applied to an unbonded flexible pipe and its applications warrant the use of these elements, as they are exceptionally versatile and configurable to be applied to unbonded flexible pipes due to their resulting bendability, durability and compressible strength. Further, when the thermal layers are provided in an overlapping, interlocking way, less strength may be needed by the armour layers and this may reduce the resulting weight of the unbonded flexible pipes. Further, the laying of the elements may also be eased.

In an embodiment of the element according to the invention the thermal insulating element has a hole/base material volume ratio in the order of between about 2% to about 98%, preferably between about 5% to about 95%, more preferably between 45% and 93%, such as larger than 50%, such as larger than 60%, such as larger than 80%, such as larger than 90%, such as larger than 93%. Within this application, the term “porosity” is the void fraction relative to base material and is herein used to designate the fraction of the total volume of the (filled or not filled) holes relative to the total volume of the base material used in each element or within each hole configuration element length section.

Thus, the base material and/or the core filler and/or hole and/or thermal insulating element dimensions and/or configurations are selected as to render the resulting element substantially bendable, such as highly bendable at least along the first longitudinal direction of the thermal insulating element (e.g. in the z-direction), and/or further longitudinal directions and substantially non-compressible along a perpendicular line which provides the thickness of the thermal insulating element.

In an embodiment of the element according to the invention the thermal insulating element comprises at least one elongated interior hole provided with at least one sensor, such as a fibre optical sensor provided in a through hole. The sensor will then be physically protected from the environment, e.g. water, high pressure etc. This may indeed be the case if the hole is further provided with core filler e.g. also chemically protecting the sensor along the length thereof.

An embodiment of the element according to the invention is bonded to or welded to or at least in contact with a further such element along at least one side face and/or end face and/or top or bottom face thereof. The element may be provided in a long or infinite strip bonded or welded together in a length by length relation. Such bonding may be performed during extrusion manufacture, and/or in a subsequent step after extrusion, using mechanical or chemical binders, such as stamping or heating or an adhesive, or any other suitable welding or bonding process, taking into account e.g. the type of base material being used, the resulting desired bendability of the element, and/or the type of core filler within, and the skilled person is aware of several other ways of performing this. Another configuration is to provide one element on top of one or more other elements. Again a further parameter is provided, enabling a more or less rigid element in the resulting sandwich configuration.

According to the invention, there is also provided a subsea structure comprising at least one such thermal insulating element. Some examples of subsea structures aside from flexible pipes may be non-flexible steel pipes, pumps, joints, assembly cabling, wet christmas trees, jumpers, single tubular, pipe-in-pipe and the like. However, the designed bendability of the element makes it highly useful around more complexly shaped structures, such as flexible structures. The resulting configurable thermal insulating elements are excellent for joining together and forming an insulating layer or layers around structures to be protected against sea pressures and temperatures. The element may suitably be of a base material which allows for bonding, e.g. by adhesive or by another binding agent or by any other attachment means, such as clamps, or by hinging to the subsea structure or to each others, or the like, as it is available for the skilled person.

According to the invention, there is also provided an unbonded flexible pipe comprising a thermal insulating layer comprising at least one such thermal insulating element. In an embodiment of the flexible pipe according to the invention at least one element is wound around the flexible pipe. In an embodiment of the flexible pipe according to the invention the element is in the form of an infinite strip wound around the flexible pipe, such as wound helically around the flexible pipe. In an embodiment of the flexible pipe the element is lying around the flexible pipe with such a lay angle theta that at least said first longitudinal direction of the element coincides with the radial direction of the pipe or alternatively coincides with the lay angle theta.

An embodiment of the flexible pipe according to the invention comprises one or more layers of thermal insulating elements. In another embodiment of the flexible pipe according to the invention at least two wound elements are in contact, such as overlap, such as interlock each other.

According to the invention, there is also provided a method of manufacturing such a thermal insulating element comprising providing a base material, preferably a resin such as a polymer or a polymeric mixture, preferably an extrudable polymer, extruding said base material in an element length thereof, and during or after said extrusion providing at least one first series of hole configurations, said first series comprising a plurality of elongated interior holes, each comprising a central hole axis (A) along its elongation, in such a way that each central hole axis extends substantially mutually in parallel to each other at least along a first longitudinal direction, wherein each hole in a plane perpendicular to the first general longitudinal direction comprises a cross sectional hole shape, and wherein the elastic modulus E of said base material at least along said first longitudinal direction is equal to or larger than 1.5 GPa.

In an embodiment of the element manufacturing method according to the invention at least said first longitudinal direction and/or said the element length coincides with an extrusion direction during extrusion. An embodiment of the element manufacturing method according to the invention comprises providing the holes during extrusion by stratification on one top surface of said element of a plurality of longitudinally extending grooves, which during or after extrusion are iclosed again e.g. by rolling on top of said top surface or by providing a further covering layer of base material. An embodiment of the method according to the invention further comprises that said core filler is provided into at least a part of said holes during or after said stratification, such as before, during or after the overlaying, such as after said thermal insulating element has solidified.

According to the invention, there is also provided a method of manufacturing an armoured unbonded flexible pipe comprising laying at least one thermal insulating element around the flexible pipe with such a lay angle theta that at least said first longitudinal direction of the element coincides with the radial direction of the pipe or with the lay angle theta. It is an advantage to be able to design the element for the intended lay angle theta of any specific pipe, such that the bendability of the element may be adapted for easing the lay process, for alignment with a lay angle theta of a value between where the largest bend of the element is obtained, i.e. when the element is applied radially upon the surface of the pipe, and where the lowest bend of the element is obtained, i.e. when the element is applied longitudinally along the pipe.

All features of the invention including ranges and preferred ranges can be combined in various ways within the scope of the invention, unless there are specific reasons for not to combine such features.

An example of such engineered thermal insulating element exhibit
an average thermal conductivity below about 0.10 W/m·K,
a compressive strength i.e. can withstand an outside/inside pressure of about 10 MPa or more at 90° C.,
a modulus in tension of about 100 MPa or less at 23° C., and
an elongation at the threshold of plastic deformation of about 7% or more at 23° C.

Furthermore the thermal insulating element can be produced in a very simple manner e.g. by extrusion or by a method comprising extrusion, and may be made from readily available and cost-effective materials.

In the following description and examples, further benefits of the invention and embodiments thereof will be described.

### BRIEF DESCRIPTION OF DRAWINGS

The invention will be explained in more detail below in connection with preferred embodiments and with reference to the schematic drawings, in which:

FIGS. 1A, 1B, 1C show different thermal insulating elements of the invention seen in sectional cuts perpendicular to their respective element lengths;

FIG. 2 is a perspective view of two elements according to the invention, positioned side by side;

FIG. 3 is a schematic top view of a thermal insulating element seen in a sectional cut in a plane perpendicular to the thickness of the thermal insulating element;

FIG. 4A, 4B, 4C, 4D are schematic top views of thermal insulating elements of the invention with different hole extending directions and seen in sectional cuts in planes perpendicular to the thickness of the respective thermal insulating elements;

FIG. 5A, 5B, 5C are schematic top views of thermal insulating elements of the invention with different hole inter-connectivity and seen in sectional cuts in planes perpendicular to the thickness of the respective thermal insulating elements;

FIG. 6 shows a tubular thermal insulating element of the invention seen in sectional cuts perpendicular to its element length;

FIG. 7 shows a thermal insulating element of the invention with a channel shaped top surface and seen in sectional cuts perpendicular to its element length;

FIGS. 8A-8K show different thermal insulating elements of the invention with different cross sectional hole shapes and seen in sectional cuts perpendicular to their respective element lengths;

FIG. 9 shows a thermal insulating element of the invention with a closed packed pattern of holes and seen in a sectional cut perpendicular to its element lengths;

FIG. 10 shows three thermal insulating elements of the invention placed on top of each other and seen in sectional cuts perpendicular to their respective element lengths;

FIG. 11 shows a thermal insulating element of the invention with a parallelogram shaped profile and seen in a sectional cut perpendicular to its element lengths;

FIG. 12 shows a thermal insulating element of the invention with a Z-shaped profile and seen in a sectional cut perpendicular to its element lengths;

FIG. 13 shows a thermal insulating element of the invention with a profile with a concave side and a corresponding convex side and seen in a sectional cut perpendicular to its element lengths;

FIG. 14 shows a schematic and perspective view of two thermal insulating elements connected to each other in an end to end relation;

FIG. 15 shows a schematic and perspective view of two other thermal insulating elements connected to each other in an end to end relation;

FIG. 16 shows a thermal insulating element of the invention in an embodiment seen in three sections S₁, S₂ and S₃; and

FIG. 17 shows a perspective side view of an armored unbonded flexible pipe according to the invention.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

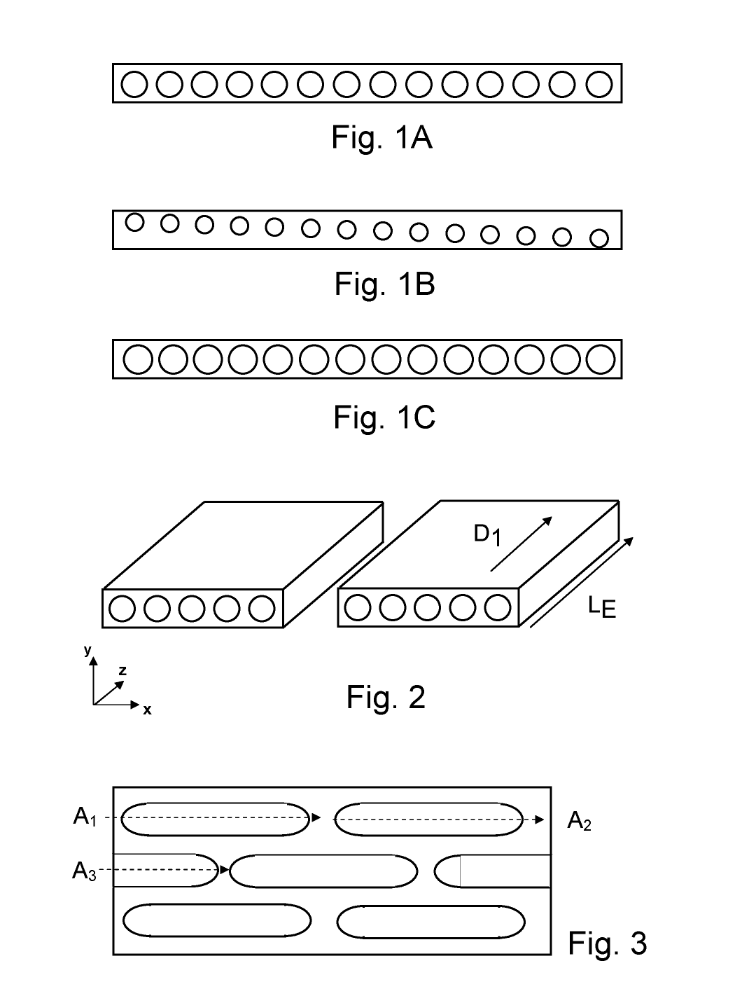

FIGS. 1A, 1B and 1C show three different elements in schematic side views from one end of the elements according to three different embodiments of the invention.

In FIG. 1A a series of holes is provided, in total fourteen equidistant, similarly shaped circular holes provided next to each other along a first series along a linear line in a base material. The diameter of each hole is larger than the distance between two such holes. The view is seen in a plane substantially perpendicular to the element length, and each of the circular shapes is the cross sectional hole shape. The shortest distance between the top or the bottom surface of the element and a hole is comparable to the distance between two holes.

In FIG. 1B a series of holes is provided, in total fourteen equidistant, similarly shaped circular holes in a base material. The diameter of each hole is substantially equal to the distance between two such holes. Further, the shortest distance between the top or the bottom surface of the element and a hole is shorter than the shortest distance between two holes.

In FIG. 1A a series of holes is provided, in total fourteen equidistant, similarly shaped circular holes in a base material. The diameter of each hole is substantially larger than the distance between two such holes. Further, the shortest distance between the top or the bottom surface of the element and a hole is shorter than the shortest distance between two holes.

The three FIGS. 1A to 1C illustrate that a number of holes are provided in a series in a first hole configuration, wherein the element width and height are the same in all three cases, but where the hole diameters differ, and thus the distances as explained above. Even though the base material is the same, the resulting flexural modulus of the element is quite different in the three cases. The element of FIG. 1A is bendable along the length (not shown) thereof, the element of FIG. 1B is less bendable and the element of FIG. 1C is more bendable than the element of FIG. 1A.

FIG. 2 is provided to illustrate the element length L_{E}, width and thickness, and the three dimensional coordinate system X, Y, Z, which has been used to define and simplify the following examples. An element thickness is the distance between the top and bottom surface of the element in the y-axis direction, an element width is the distance between one side surface of the element to the other side surface in the x-axis direction, and an element length L_{E} is the direction or distance between element end surfaces in the z-axis direction, since this side of the substantially flat oblong box-shaped element is longer than the other lateral sides. Two elements are provided side by side, each comprising a series of five holes in all, each hole extending mutually in parallel to each other hole, and as indicated with the arrow D₁ each hole extends within an element in parallel along this first longitudinal direction. Only the ends of the holes are visible on FIGS. 1A-1C and 2. All the holes are provided going entirely through each element, each such through hole ending on the end surface, which is not visible from the presented element end.

FIG. 3 shows a view from a top surface of an embodiment of the element, cut in a plane extending through the middle of the width thereof, so that another configuration of the holes is evident. There are provided three rows of non-through holes provided along each their mutually parallel lines along a first longitudinal direction (not shown). In the first row, there are provided two non-through holes, entirely encompassed within the base material, one of the holes herein being elongated along the central axis A₁, and the other being elongated along the central axis A₂. A₁ and A₂ extend along the same general direction along the same linear line. I.e. said at least one series of five hole in a hole configurations comprises at least one line of at least two successive non-through holes in line with each other. In the second row, three non-through holes with central hole axes such as the first one indicated A₃, are provided along the same line, where the longitudinal length of the two outer holes is approximately equal to half the longitudinal length of the middle closed hole. In the third row, two more elongated interior entirely closed holes are provided in line with each other. As is shown, the second row may be said to be displaced half a hole in relation to the first and third row. The elongation length of each of the closed holes in all three rows is equal to each other. Further, the diameter of the generally circular holes is also the same for each hole. The elongation length of each hole is approximately seven times larger than the diameter thereof.

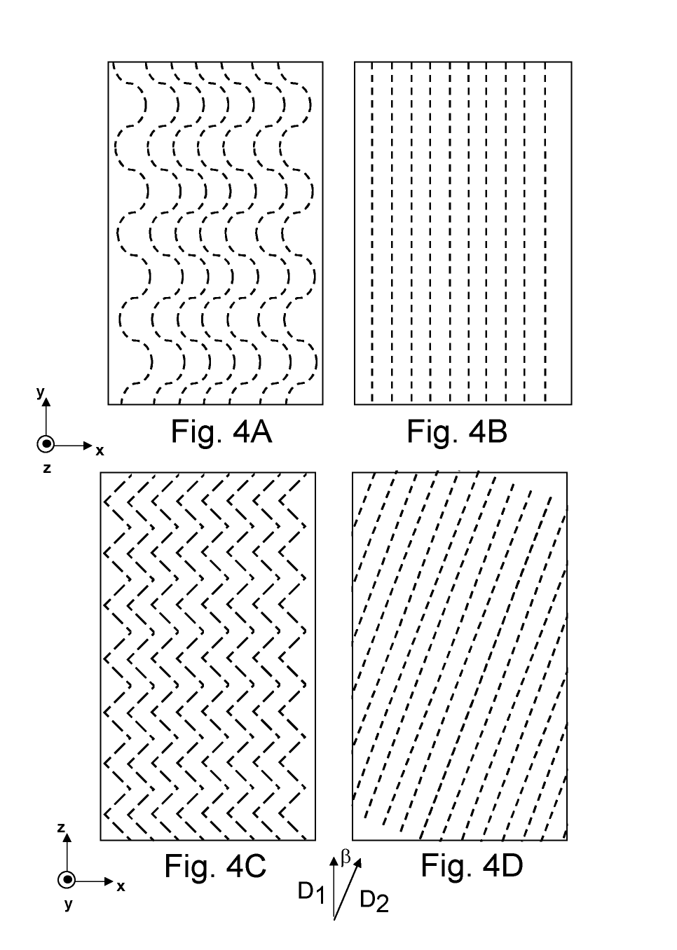

FIG. 4A-4C are all seen from a top surface of each element and show examples of different line configurations of the elongated holes. FIG. 4A shows an embodiment of an element according to the invention, which is provided with wavy interior through holes, indicated by the use of broken lines and without indicating the diameter of each hole. As may be seen, the wavy lines extend along a general longitudinal direction D₁ while they at the same time are all mutually parallel to each other, substantially equidistant to each other. FIG. 4B shows an embodiment of an element according to the invention, where the linear through interior elongated holes are provided equidistantly and mutually parallel to each other, and extends along the same general longitudinal direction D₁. In FIG. 4C, each through hole is provided along mutually parallel and equidistant zigzag lines, again extending along the same general longitudinal direction D₁. In FIG. 4D, the mutually parallel and equidistantly, linearly provided elongated interior holes all extend in a further and different general longitudinal direction D₂. Said longitudinal direction D₂ extends with an angle alpha to the element length L_{E} extending in the z-axis. Further, said longitudinal direction D₂ extends with an angle beta to said first general longitudinal direction D₁. The angles alpha and beta are here the same, approximately 22 degrees.

If one were to overlay the element as shown in FIG. 4B with the element as shown in FIG. 4D one on top of the other, the resulting sandwich element would be provided with different element properties, such as decreased flexural modulus along the element length, and improved thermal insulation property.

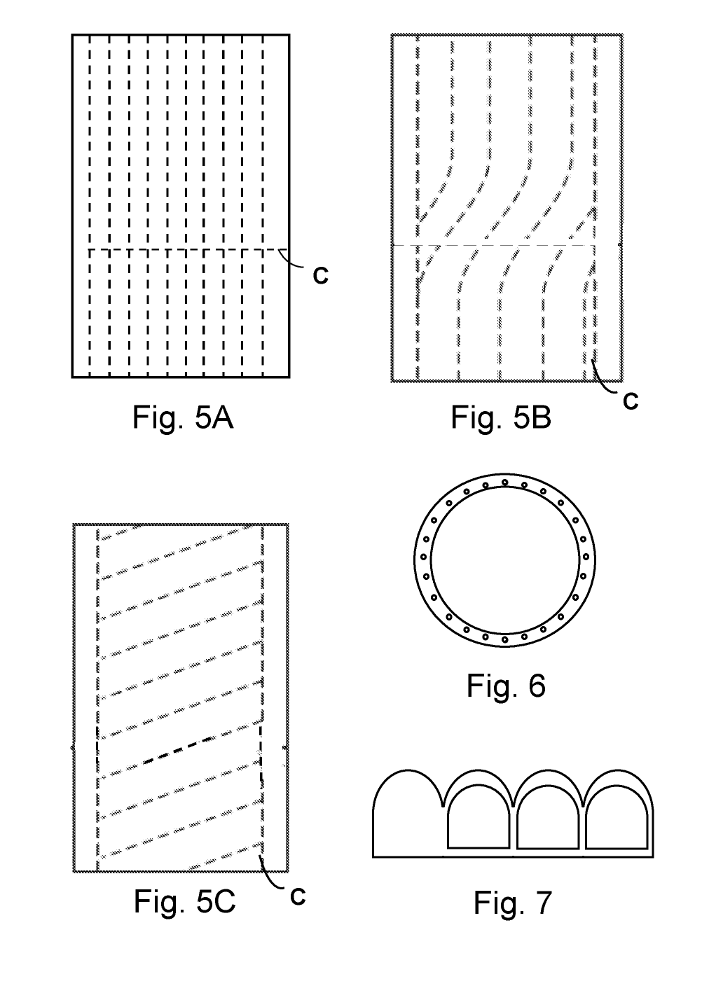

FIGS. 5A-5C show some examples of elements having different types of connections holes C.

FIG. 5A shows an element according to an embodiment of the invention, where the element using a drilling process has been provided with a connection hole C, lying perpendicular to the longitudinal direction of the elongated holes. The connection hole C interconnects all the mutually parallel interior holes with each other, and the connection hole end is exposed on one element side surface thereof, being suitable e.g. for filling core filler into. A suitable core filler (not shown) has been supplied to all holes through this connection hole C. Alternatively, a core filler may be supplied in all holes, including connection hole C during manufacturing of the element; or through any or all of the holes, including the connection hole C. Further connection holes may be provided, and along other directions as well. The connection hole C may also be provided before solidifying of the polymer matrix of the base material.

FIG. 5B shows an element according to an embodiment of the invention, where the interior elongated holes are provided in such a way that all the interior holes are interconnected by the provision of two linear through holes, as seen in the left and right most side of the figure. The larger part of each elongation length of the five other elongated holes extends substantially mutually parallel to each other, as it may be seen in FIG. 5B, which is also intended with the scope of the claimed invention. Further, the general longitudinal direction of the series of holes coincides with the element length.

FIG. 5C shows an element, where the interior elongated holes are provided in such a way in the base material that all the interior holes are interconnected by the provision of two linear through holes, as seen in the left and right most side of the figure. Again, the larger part of each elongation length of the five other elongated holes extends substantially mutually parallel to each other. This time though along a different general longitudinal length extending with an angle alpha of approximately 45 degrees to the element length (Z-axis).

FIG. 6 shows an element according to an embodiment of the invention, where the element is provided substantially tubular, the end face of the element being illustrated here in a cut perpendicular to the element length. A plurality of elongated interior holes, twenty four in all, are provided within the tubular element, and as is seen, the plane in which the elongated holes of the series of hole configurations extend is substantially tubular as well. Such tubular element may be provided e.g. after the extrusion step in a further bending process, preferably before the base material solidifies. Alternatively, the tubular element is provided integrally during a tubular extrusion process. Such tubular element may be suitable for a small diameter piping, such as less than 30 cm. The flexural modulus of the element along the length thereof may be increased substantially in such tubular element, which may be alleviated by proper selection of more bendable base material and hole configuration parameters.

FIG. 7 shows an example of an element from an end surface thereof, wherein the element is of different cross sectional element shape than a quadrilateral shape, as shown above in FIGS. 1-5C. The cross sectional element shape comprises a linear bottom line and two perpendicular mutually parallel side lines on each line end thereof, and the top line extends between said two side lines in four approximately half-circular lines provided next to each other. This shape enables the provision of an increased hole shape area to base material area ratio at least in a section of said element. Three elongated holes are provided in the element, seen from an end surface thereof, having cross sectional hole shapes, which conform to the outer boundaries of the cross sectional element shape. The leftmost element section is intentionally left without a hole structure, due to the fact that at least this section may then exhibit an increased flexural modulus as compared to the flexural modulus in the section of the element, in which holes are provided. Such hole-less section may improve the laying process when applying the element to a subsea structure. Core filler, e.g. a phase changing core filler is provided within the hole voids, in order to increase the strength, when the phase shifting material changes its viscosity/flexural modulus due to the impact of pressure forces and/or temperatures lowering in e.g. deep waters. Selection of advantageous cross sectional element shapes, also in the Y-axis and Z-axis, is a parameter to be utilized when designing such elements for a particular use.

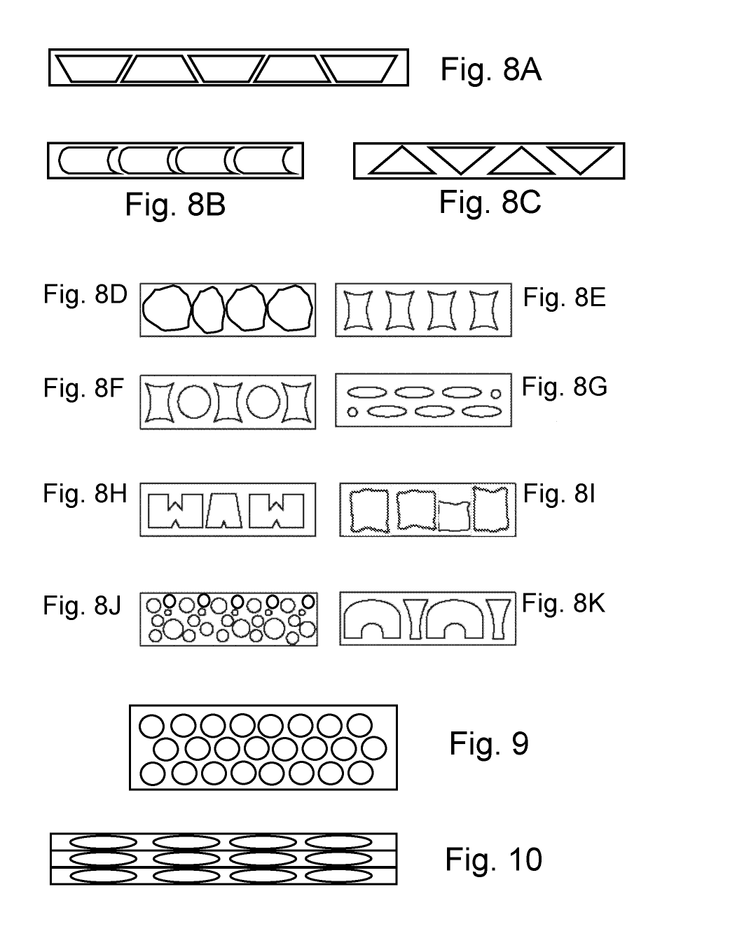

FIGS. 8A-8K and 9-10 show different examples of cross sectional hole shapes perpendicular to the element length, which shape selections are beneficial when designing specific elements.

FIG. 8A shows five hole shapes of rhomboid or parallelepiped form, of similar shape, however, every second shape is turned 180 degrees in order to provide increased strength impact of the core filler. The core filler is ambient air in FIG. 8A. The wall thickness of the base material between two adjacent holes and between a hole and the top or bottom surface of the element is quite small, approx 10 times smaller compared to the largest diagonal of the hole shape, which is equal to the longest lateral side of the hole shape. When in use, the element is subjected to pressure gradients along the Y-axis (thickness) of the element, here extending along the vertical direction of the figure. The provision of ambient air, i.e. a gas, in these relatively large area hole shapes significantly improves the thermal conductivity of the element. This is a further advantage of the element of the invention, as this element parameter hole shape area to base material area ratio may also be designed according to desires, taking into account the thermal conductivity of the gas and the base material in combination.

FIG. 8B shows four similar hole shapes extending along the same plane, i.e. a line along the X-axis, which shapes are beneficial for redirecting the vertical pressure forces to a pressure force acting in the horizontal direction of the element, to the leftmost side of the figure in this case. The element holes are filled entirely, i.e. 100% with a mineral oil and the cross sectional shape and size of the hole is selected with this purpose in mind. The shape comprises two linear parallel lines, top and bottom lines of equal length and positioned directly above each other, where the left end points of the two lines are connected via a semicircular convex line, and the right end points are connected via a semicircular concave line.

FIG. 8C shows four similar cross sectional hole shapes of a triangular shape, where the base line is longer than the two side lines. The wall thickness between two adjacent holes is substantially constant and approximately equal to half the length of the base line of the hole shape. However, the wall thickness between the base line and the element top/bottom surface is approximately three times shorter than the wall thickness between two adjacent holes. The holes are filled with a non-compressible high viscosity core filler, such as silicone grease, and the shape of the holes and the mentioned wall thicknesses supports the core filler in such a configuration that both the compression strength of the element and the thermal insulating property are increased.

FIG. 8D shows four irregularly sized, shaped and positioned circular holes, which are irregular due to large tolerances during manufacturing. The provision of precise positioning, size, and hole shape is thus not required for a well functioning element to be produced. This further reduces the manufacturing costs.

FIG. 8E shows four star-shaped polygons, where the wall thickness between two adjacent holes is increased. This is an advantage in that the base material is made from a relatively non-compressible material, while the core filler is provided as e.g. aerogel, which lowers the thermal conductivity of the element significantly.

FIG. 8F shows five holes, where every second hole shape is similar to each other, and every adjacent hole is different from each other. Two circular hole shapes and three substantially star shaped holes are provided, where the circular holes house basalt fibres extending along the element length inside substantially the entire volume of the linearly extending elongated interior mutually parallel holes. The star shaped holes are filled with 50 volume % grease core filler and 50 volume % inert gas. Thus, the longitudinal strength providing effect of the fibres is used, while at the same time providing decreased element flexural modulus by the provision of an elastic core filler mixture. Further, the compression strength of the element is increased.

FIG. 8G shows different size oval and circular cross sectional hole shapes, one set of holes above the other set, where each set comprises three adjacent oval holes and one circular end hole to fill up the cross sectional area. Both sets are provided in the same series of hole configurations. The major part, substantially around 80% of the element cross sectional area is provided by hole area. Increased bendability along the element length is provided, as well as lowered thermal conductivity, even in the parts where there are significant wall thicknesses between the individual holes, which wall thicknesses may tend to otherwise increase the thermal conductivity over the thickness of the element.

FIG. 8H provides three hole shapes, which shapes resemble lettering. Thus, e.g. the manufacturer may insert company name or material and/or element properties within these hole shapes. These letter shapes are also filled with an appropriate core filler.

FIG. 8I shows four substantially quadratic hole shapes beside each other, where both the wall thickness between adjacent holes and the wall thickness between a hole and the exterior of the element are approximately of equal length and almost the entire element area is provided with hole voids.

FIG. 8J shows a plurality of regular circular hole shapes of varying sizes, all lying in different planes in the same first series of hole configuration. Such configuration may be an advantage, when the base material exhibits relatively high thermal conductivities.

FIG. 8K shows two “portal” shaped hole shapes and two “pillar” shaped hole shapes, intermittently positioned such that the resulting compression strength of the element may be increased.

FIG. 9 shows three rows of one hole configuration, with eight similar circular holes in each, each row extending substantially linearly and mutually in parallel along the X-axis. The upper row and the lower row extend along the element length in a first longitudinal direction (not shown) and the middle row extends in a second longitudinal direction (not shown), with an angle beta to the first longitudinal direction. The middle row is displaced right along the element width as compared to the upper and lower row. The holes are provided within one singular element, e.g. by extrusion of three layers and combined before solidifying.

FIG. 10 shows an element in a view of a plane perpendicular to the element length, i.e. from an end surface thereof along the X-axis. There are provided three planar element layers overlaid one upon the others within the element. The three layers are bonded to each other by a suitable adhesive. Four oblong holes are provided in each element layer, the dimension of each oval diagonal along the X-axis being approximately four times the dimension of the oval diagonal along the Y-axis. Thus, one element is provided by sandwiching a number of element layers together in a combined element structure. This may further reduce production costs of elements according to the invention.

Also, the same or different embodiment of an element FIG. 10 may illustrate a view from a top surface of the element (along the Z-axis), wherein the oval hole shapes shown are the elongation hole shapes in a cut through the axes thereof. Accordingly, a flat strip element is provided, wherein the closed holes extend along three lines mutually parallel to each other, each line extending in each their separate element layer. Each element layer is of a small width comparable to the smallest diagonal of the oval elongation hole shapes, and may thus in itself exhibit increased bendability. However, each element layer is adhered to another element layer on a side surface thereof, providing the sandwich element structure with decreased bendability.

Likewise, in the same or different embodiment of an element, FIG. 10 may also illustrate a view from a plane parallel to the element length (along the Y-axis), i.e. from the side surface of the element. There are provided three planar element layers overlaid one upon the others within the element, and the element layers are bonded together by welding on a top and/or bottom surface thereof to another element layer.

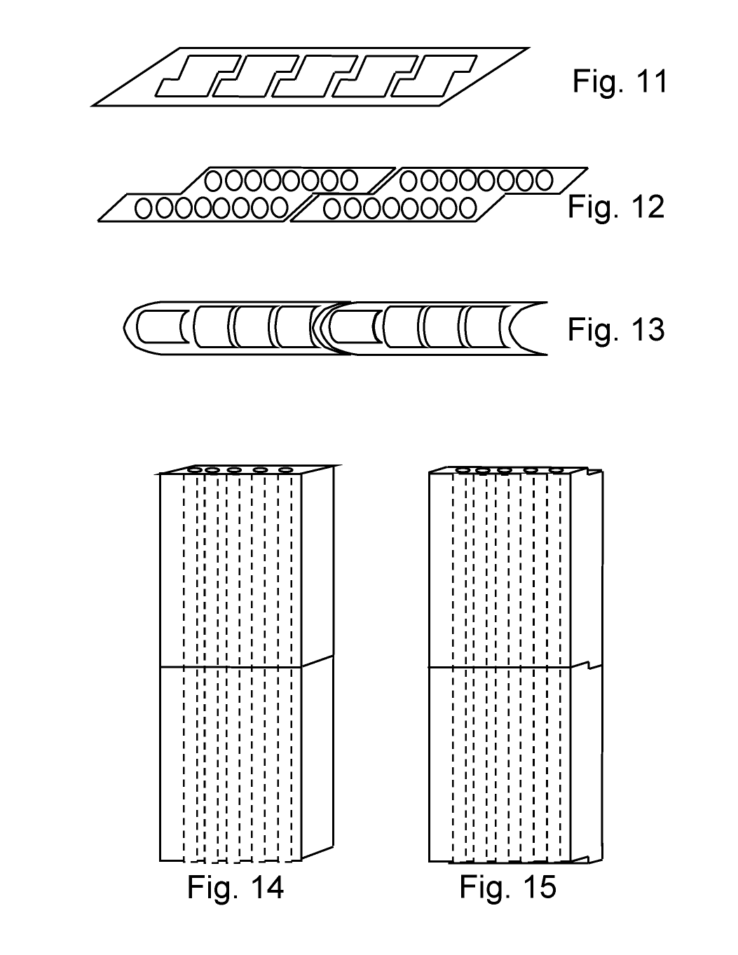

FIGS. 11-13 show three embodiments of the element from end views. The element shape of these figures is suitable for contacting or overlapping a similar shaped element, which may ease the laying process during manufacturing, and may hold the element in place relative to such adjacent similar shaped element at least in the X-axis thereof. Further, the element may be provided with an element shape which also or alternatively comprise such overlapping parts in the Y- and/or Z-axis thereof (not shown). The base material is provided with an increased flexural modulus in order to provide such support

FIG. 11 illustrates a rhomboid or parallelogram shaped element, i.e. having bevelled side surfaces. The element comprises five similar polygonal hole shapes, provided in the same series of hole configurations. The polygons are octagons in the form of a low angle, mirrored Z of such tile shape that the lower part of one hole shape fits in precisely below the upper part of the adjacent hole shape. FIG. 12 illustrates two similar elements provided in a side by side relationship, contacting one side surface of each other for providing said holding effect. The element shapes are polygons in the form of a low angle, mirrored Z of such tile shape that the lower part of one element shape fits snugly below the upper part of the adjacent element shape. The holes are provided as two series of eight circular holes, in two parallel rows above each other, so that they fit into said lower/upper part of the element shapes. FIG. 13 illustrates two elements side by side having similar element shapes suitable for overlapping, where the leftmost side line is semicircular concave and the rightmost side line is semicircular convex, each side line semicircle having approximately the same radius, advantageously one of the semicircles have slightly lower/higher radius than the other such that machining tolerances may be met.

FIGS. 14 and 15 each show two similar flat elements in a semi perspective view, such that it can be seen that they are positioned along the element lengths in line with each other. The upper and lower end surfaces, respectively, of each element contact each others such that an even longer element structure is obtained. The mutually parallel, along the element length extending, linear interior elongated through holes then lie flush against each other, e.g. for enabling a fluid flow through the two elements therethrough. In FIG. 14, the end surfaces are substantially flat and plane, providing a good contact through adhesion between the two. In FIG. 15, the end surfaces are provided with a step in each end such that the contact surface area is increased in order to provide a better bonding between the two elements. Other such notches, steps, arrows, feather and spline structures are known by the skilled person and can be used as desired for providing contact surfaces and/or structural stability during the laying of the elements. These structures may also or alternatively be provided along any other surface on the element as desired, and may even be provided with engagement means such as projections for engagement with e.g. the adjacent hole or holes of another element.

Two or more such elements may be provided alongside each other as shown, along any and/or all axes, e.g. for providing a longitudinally extending long flat element, or for providing a multileveled structure for increased insulation effect and/or strength.

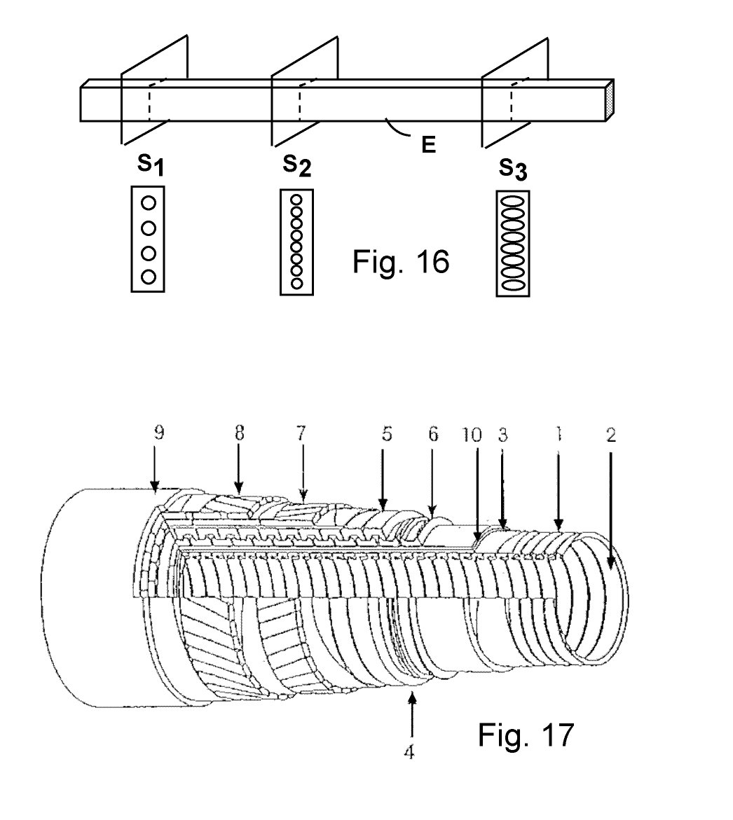

FIG. 16 shows a long flat strip or element E, wherein the sectional cuts S₁, S₂, and S₃ show the hole configuration varying along the length of the element, where the number, size, and shape of the holes vary. S₁ shows four large diameter circular holes in the base material, which hole diameter decreases towards the section S₂ while the hole number increases to eight. This change takes part either along a length section of the element between S₁ and S₂ or at one point or element end surface contact somewhere between S₁ and S₂. Further, the diameter of the circular holes increases along the width/thickness of the element between S₂ and S₃ such that oval hole shapes are provided at this section. The base material is the same uniform material along the element length. A non-compressible core filler is provided in the holes. Thus, the element provided can be used in such a way on a structure to be insulated that the part around section S₁ is provided in a low pressure, high temperature environment, (100 kPa, 20 degrees Celsius), the part around section S₂ is provided in a medium pressure, medium temperature environment (105 kPa, 10 degrees Celsius), and the part around section S₃ is provided in a high pressure, low temperature environment (130 kPa, 2-3 degrees Celsius). The high pressure environment is counteracted by the increasingly high compression strength of the element due to the larger volume of the non-compressible fluid in the holes near the section S₃. At the same time, the core filler in combination with the base material selected provides the proper thermal conductivity needed for insulating the structure in question in the low temperature environment. The medium pressure environment is counteracted by the selected compression strength of the element due to the low volume of the non-compressible fluid in the holes near the section S₂. At the same time, the low volume of core filler in combination with the large volume base material provides the proper thermal conductivity needed for insulating the structure in question in the medium temperature environment. The low pressure environment is counteracted by the increasingly lower compression strength of the element due to the now even smaller volume of non-compressible fluid in the holes near the section S₁. At the same time, the low volume and optionally different type of core filler in combination with the base material selected provides the proper thermal conductivity needed for insulating the structure in question in the high temperature environment.

It has thus been realized that by proper selection of hole, base material configuration as described above, the amount of base material may be kept at a minimum, which reduces the total mass of the element, and thus the mass of the structure to be insulated. This in turn reduces material costs, manufacturing costs, structure load, and decreases environment loads, when the element is to be recycled.

All the FIGS. 1-16 show a limited number of holes in said series of hole configurations—However, there is often provided a larger number of holes in the element according to the invention for applying the principle of designed bendability. Further, the distances, lengths, widths, and thicknesses may also be exaggerated or diminished in the figures. Also, the examples provided are not intended to be limiting, and the skilled person may combine and/or remove any of the suggested features as they are claimed in the following. The drawings and examples are provided purely for explanatory reasons to illustrate the examples and explain the different parameters and features of the element according to the invention.

A subsea structure is provided in FIG. 17, showing an armoured unbonded flexible pipe 1 comprising thermally insulating elements of the invention. The figure shows the flexible pipe 1, which comprises an inner liner 3 which surrounds the liquid and/or gas to be conveyed during production of carbohydrates. This liner prevents any gas or liquid leaking from the inner void of the liner 3. Within the liner is a carcass consisting of a helically wound metal tape 2. During manufacture, the metal tape 2 is formed with engaging parts so that they hereby interlock the individual windings of the metal tape 2 together in such a manner that the carcass 1 can be bent along the longitudinal direction of the pipe. One or more layers 10 of the element or elements according to the invention are applied by extrusion onto the inner liner with a lay angle theta relative to the longitudinal axis of the pipe. The function of this layer or layers 10 is to ensure a sufficient thermal insulation between the fluid transported inside the pipe and the surrounding armour layer. On the outer side of the insulation 10, one or more layers of profiles 5, 6 are wound in a helical manner with a large angle in relation to the longitudinal direction of the pipe 1, such that they provide pressure armouring against the radial forces that act upon the pipe 1, such as inner and/or outer pressures from the transported liquids or from the layers, and from the sea water, respectively. Further, tensile armouring consisting of two helically wound layers 7, 8 with a small angle to the longitudinal length of the pipe is provided on the outside of the pressure armour. Between the pressure armour and the tensile armour an intermediate sheath 4 is provided in order to prevent fluids from migrating between the tensile and pressure armour. Finally, an outer sheath 9 is provided on the outside of the tensile armouring 7, 8. The insulation may also or alternatively be provided between the two armouring types.

Other positioning and laying of the insulation element may also be contemplated, e.g. by placing element plates or tubular element piping on, around or onto the outside of the liner 3, and/or between the armouring 5, 6 and 7, 8, because then the armouring tapes can assist in holding the thermal insulating elements in place. A further element position is on the outside of the armouring 7, 8.

The element is preferably manufactured by extrusion, however other manufacturing methods may be applied, such as injection blow moulding, die moulding, compression moulding, or other process known to the skilled person.

A method of manufacturing a thermal insulating element comprises providing a base material, preferably a resin such as a polymer or a polymeric mixture, preferably an extrudable polymer, as described above. Then the base material is extruded to form an element having an element length. During or after the extrusion a series of hole configurations are provided within the base material. The series comprises a plurality of elongated interior holes, each comprising a central hole axis A along its elongation that extends substantially mutually in parallel to each other at least along a first longitudinal direction. Each hole in a plane perpendicular to the first general longitudinal direction comprises a cross sectional hole shape. The elastic modulus E of said base material at least along said first longitudinal direction is equal to or larger than 1.5 GPa. Said first longitudinal direction and/or said the element length can advantageously coincide with an extrusion direction during the extrusion process. The elongated holes may be provided during extrusion by stratification on one top surface of said element and providing a plurality of longitudinally extending grooves, which during or after extrusion are closed again, e.g. by rolling longitudinally on top of said top surface or by providing an overlay or a further layer of base material. The core filler can be provided into at least a part of said holes during or after said stratification. The core filling process may be performed before, during or after the groove closing process, such as after said thermal insulating element has solidified. Through holes and/or connection holes may be provided during or after extrusion, or they may be provided through the solidified base material, e.g. with a drilling tool. During extrusion, the connection holes may also be provided in a way similar to the mutually parallel holes.

A method of manufacturing an armoured unbonded flexible pipe comprises laying at least one thermal insulating element around the flexible pipe with such a lay angle theta that at least said first longitudinal direction of the element coincides with the radial direction of the pipe or with the lay angle theta. Any other angle there between is also conceivable. The large number of possible positioning of the element upon the pipe or subsea structure is one of the advantages of the present invention.

The element layer or layers 10 may be provided upon the pipe in such a way, that the first longitudinal direction and/or further longitudinal directions of the at least one series of hole configurations are provided along the element length, which again is provided along a lay angle theta relative to the longitudinal axis of the pipe, which angle theta can be any value between 0 and 90 degrees. However, in an advantageous embodiment, the first direction and/or further longitudinal directions of the at least one series of hole configurations are provided with an angle alpha₁ . . . alpha_{N} relative to the element length, such that at least one of the angles alpha₁ . . . alpha_{N} plus the lay angle theta is equal to 90 degrees. The element length and/or a longitudinal direction can coincide with (or is a tangent to) the radial circumference of the pipe. The element length and/or a longitudinal direction can also or alternatively be provided in parallel to i.e. coinciding with the longitudinal axis of the pipe.

Some preferred embodiments have been shown in the foregoing, but it should be stressed that the invention is not limited to these, but may be embodied in other ways within the subject-matter defined in the following claims.

What is claimed is:

1-62. (canceled)

63. A thermal insulating element having an element length, where said element comprises a base material comprising at least one first series of hole configurations, said first series comprising a plurality of elongated interior holes, each comprising a central hole axis (A) along its elongation, each central hole axis extending substantially mutually in parallel to each other at least along a first longitudinal direction, wherein each hole in a plane perpendicular to the first general longitudinal direction comprises a cross sectional hole shape, and wherein the elastic modulus E of said base material at least along said first longitudinal direction is equal to or larger than 1.5 GPa.

64. The element according to claim 63, wherein said plurality of elongated interior holes comprises at least three holes, such as at least four holes, such as at least five holes, such as at least ten holes, such as at least twenty holes, such as at least fifty holes.

65. The element according to claim 63, wherein at least said at least one first series of hole configurations extends in the same series directions, however, it does not necessarily have to extend in a flat plane.

66. The element according to claim 63, wherein each of said holes have a hole length along said central hole axis of at least about 2 mm.

67. The element according to claim 63, wherein each of said holes have a hole length along said central hole axis of at least about 5 mm.

68. The element according to claim 63, wherein each of said holes have a hole length along said central hole axis of at least about 1 cm, such as at least about 2 cm.

69. The element according to claim 63, wherein each of said holes have a hole length along said central hole axis of at least about 5 cm.

70. The element according to claim 63, wherein each of said holes have a hole length along said central hole axis of at least about 10 cm.

71. The element according to claim 63, wherein each of said holes have a hole length along said central hole axis of at least about 20 cm.

72. The element according to claim 63, wherein each of said holes have a hole length along said central hole axis of at least about 50 cm.

73. The element according to claim 63, wherein each of said holes have a hole length along said central hole axis of at least about 1 m.

74. The element according to claim 63, wherein each of said holes have a hole length along said central hole axis of at about 10 m.

75. The element according to claim 63, wherein each of said holes have a hole length along said central hole axis equal to the entire length of the element i.e. continuously.

76. The element according to claim 63, wherein a maximal length of an inner diagonal of at least one of the cross sectional hole shapes is equal to or larger than the minimal distance between said cross sectional hole shape and another adjacent cross sectional hole shape, i.e. the minimal distance between the hole in question and an adjacent hole, wherein the hole in question and the adjacent hole may be part of the same at least one series of hole configurations.

77. The element according to claim 63, wherein a part of or the whole of the base material exhibits a thermal conductivity of about 0.3 W/m·K or less.

78. The element according to claim 63, wherein a part of or the whole of the base material exhibits a thermal conductivity of about 0.25 W/m·K or less.

79. The element according to claim 63, wherein a part of or the whole of the base material exhibits a thermal conductivity of about 0.2 W/m·K or less.

80. The element according to claim 63, wherein a part of or the whole of the base material exhibits a thermal conductivity of about 0.15 W/m·K or less.

81. The element according to claim 63, wherein a part or the whole of the base material is a resin such as a polymer or a polymeric mixture, preferably an extrudable polymer.

82. The element according to claim 81, wherein a part of or the whole of the polymer or polymeric mixture is a homopolymer or a copolymer comprising at least one of the materials in the group comprising polyolefins, e.g. polyethylene or polypropylene (PP), such as stiff linear copolymer PP with a branched homopolymer PP; polyoxyethylenes (POE); cycloolefin copolymers (COC); polyamides (PA), e.g. polyamide-imide, polyamide-11 (PA-11), polyamide-12 (PA-12) or polyamide-6 (PA-6)); polyimide (PI); polyurethanes such as polyurethane-isocyanurate; polyureas; polyesters; polyacetals; polyethers such as polyether sulphone (PES); polyoxides; polysulfides, such as polyphenylene sulphide (PPS); thermoplastic elastomers, such as styrene block copolymers, such as poly(styrene-block-butadiene-block-styrene) (SBS) or their selectively hydrogenated versions SEBS and SEPS; termoplastic polyolefins (TPO) e.g. comprising SEBS and/or SEPS; polysulphones, e.g. polyarylsulphone (PAS); polyacrylates; polyethylene terephthalates (PET); polyether-ether-ketones (PEEK); polyvinyls; polyacrylonitrile (PAN); polyetherketoneketone (PEKK); copolymers of the preceding; fluorous polymers e.g. polyvinylidene difluoride (PVDF), homopolymers or copolymers of vinylidene fluoride (“VF2”), homopolymers or copolymers of trifluoroethylene (“VF3”), copolymers or terpolymers comprising two or more different members selected from VF2, VF3, chlorotrifluoroethylene, tetrafluoroethylene, hexafluoropropene, or hexafluoroethylene; compounds comprising one or more of the above mentioned polymers, and composite materials, such as a polymer e.g. one of the above mentioned polymers compounded with reinforcement such as solid or hollow microspheres, e.g. made from glass, polymer or silica, and/or fibres, such as glass fibres, carbon fibres, aramide fibres, silica fibres such as basalt fibres, steel fibres, polyethylene fibres, polypropylene fibres, mineral fibres, and/or any combination thereof.

83. The element according to claim 63, wherein a part or the whole of the base material comprises a polyolefin, preferably of a polypropylene-like type, the base material in itself exhibiting a high bulk modulus above 2.2 GPa and a thermal conductivity of below about 0.2 W/m·K.

84. The element according to claim 63, wherein at least one element surface is smoothened, i.e. levelled flat and easy to slide.

85. The element according to claim 63, wherein the element has a width and a thickness perpendicular to each other and to the element length, wherein the width is from about 10 mm to about 20 cm.

86. The element according to claim 63, wherein the element has a width and a thickness perpendicular to each other and to the element length, wherein the thickness is from about 0.1 mm to about 10 cm.

87. The element according to claim 63, wherein the thickness of the element is at least 10 times shorter than the element length.

88. The element according to claim 63, wherein the thermal insulating element has an element length of at least about 5 m, such as at least about 50 m, such as an infinite length.

89. The element according to claim 63, wherein the thermal insulating element has an element length of at least about 50 m.

90. The element according to claim 63, wherein the thermal insulating element has an element length of an infinite length.

91. The element according to claim 63, wherein at least one of said holes is entirely encompassed within the element whereby the hole is a non-through hole entirely surrounded by base material.

92. The element according to claim 63, wherein the thermal insulating element comprises at least one through hole forming a path through the base material from one distal hole end to one proximal hole end.

93. The element according to claims 63, where a plurality, such as a majority, such as all of the holes in at least said at least one series of hole configurations extend substantially mutually in parallel to each other.

94. The element according to claim 63 comprising an inhomogenous distribution of number and/or sizes and/or cross sectional hole shapes of holes in at least one length section of said element.

95. The element according to claim 63 comprising a homogeneous distribution of number and/or sizes and/or cross sectional hole shapes of holes in at least one length section of said element.

96. The element according to claim 63, wherein the number of holes and/or sizes of holes decreases and/or the cross sectional hole shape changes from one length section of the thermal insulating element to another adjacent length section of the thermal insulating element.

97. The element according to claim 63, wherein the first longitudinal direction is coincident with the element length of the thermal insulating element.

98. The element according to claim 63, wherein the first longitudinal direction is not coincident with the element length of the thermal insulating element, forming an angle alpha therebetween, such as about 45 degrees or less, preferably about 30 degrees or less, more preferably about 10 degrees or less.

99. The element according to claim 98, wherein the angle alpha is about 45 degrees or less.

100. The element according to claim 98, wherein the angle alpha is about 30 degrees or less.

101. The element according to claim 98, wherein the angle alpha is about 10 degrees or less.

102. The element according to claim 63, wherein said at least one series of hole configurations comprises at least one line of at least two successive non-through holes in line with each other.

103. The element according to claim 102, wherein at least some of the holes of said at least one series of hole configurations of successive non-through holes in line with each other are of equal length at least in one length section thereof.

104. The element according to claim 102, wherein all of the holes of said at least one series of hole configurations of successive non-through holes in line with each other are of equal length at least in one length section thereof.

105. The element according to claim 102, wherein at least one line of said successive non-through holes in line is displaced in the common longitudinal direction of said holes in relation to another adjacent line of successive non-through holes in line.

106. The element according to claim 63 comprising said plurality of holes which forms a repeating pattern along the first longitudinal direction of the thermal insulating element at least in one length section thereof.

107. The element according to claim 63 comprising at least one further series of hole configurations comprising a plurality of elongated interior holes, having central hole axes along their elongation and extending mutually in parallel along a further longitudinal direction, which is different from the first longitudinal direction, and extends with an angle beta to the first longitudinal direction, beta lying between 0 degrees and 90 degrees.

108. The element according to claim 63, comprising at least one further series of hole configurations comprising a plurality of elongated interior holes having central hole axes along their elongation extending mutually in parallel along a further longitudinal direction, which direction is mutually parallel to said first longitudinal direction.

109. The element according to claim 63, further comprising one or more connection holes which interconnect two or more of said plurality of elongated, interior holes.

110. The element according to claim 109, wherein at least a pair of said elongated, interior holes, a plurality, a majority, or all of the holes in the thermal insulating element are inter-connected with one or more of said connection holes.

111. The element according to claim 63, wherein the thermal insulating element is a strip which is substantially flat.

112. The element according to claim 63, wherein at least a pair of said plurality of elongated, interior holes extends substantially along a line, such as a linear line, a wave line, a sawtooth line, a zigzag line, and/or any combination thereof, said line extending substantially along said first and/or further longitudinal direction.

113. The element according to claim 63, wherein said plurality of holes have aspect ratios, i.e. hole length/hole width ratios of about 2 or larger, such as about 3 or larger, such as about 5 or larger, such as about 10 or larger, such as about 50 or larger, such as about 100 or larger.

114. The element according to claim 63, wherein at least about 90% of the holes have aspect ratios, i.e. hole length/hole width ratios of about 2 or larger, such as about 3 or larger, such as about 5 or larger, such as about 10 or larger, such as about 50 or larger, such as about 100 or larger.

115. The element according to claim 63, wherein the central hole axis of each of substantially all of the elongated holes lies substantially in one or more planes to which a thickness axis or Y-axis is normal.

116. The element according to claim 63, wherein the central hole axis of each of substantially all of the elongated holes in at least one hole configuration lies substantially in one or more planes to which the thickness axis or Y-axis is not normal.

117. The element according to claim 63, wherein at least one of said elongated interior holes, such as both, such as a plurality, such as a majority, such as all of the holes are provided with a core filler.

118. The element according to claim 63, wherein at least one of said elongated interior holes is provided with a core filler.

119. The element according to claim 63, wherein a plurality of the elongated interior holes are provided with a core filler.

120. The element according to claim 63, wherein all of the elongated interior holes are provided with a core filler.

121. The element according to claim 118, wherein a part or the whole of the core filler is a gas, a liquid, a solid or any combination thereof.

122. The element according to claim 118, wherein a part or the whole of the core filler comprises a semi liquid material selected from the group consisting of grease, gel, bitumen, oil, or any combination thereof.

123. The element according to 118, wherein more than 50% of the area of the cross sectional hole shape and/or the volume of the hole is filled with core filler.

124. The element according to 118, wherein more than 75% of the area of the cross sectional hole shape and/or the volume of the hole is filled with core filler.

125. The element according to 118, wherein more than 85% of the area of the cross sectional hole shape and/or the volume of the hole is filled with core filler.

126. The element according to 118, wherein more than 95% of the area of the cross sectional hole shape and/or the volume of the hole is filled with core filler.

127. The element according to 118, wherein more than 97% of the area of the cross sectional hole shape and/or the volume of the hole is filled with core filler.

128. The element according to 118, wherein more than 99% of the area of the cross sectional hole shape and/or the volume of the hole is filled with core filler.

129. The element according to 118, wherein 100% of the area of the cross sectional hole shape and/or the volume of the hole is filled with core filler.

130. The element according to claim 118, wherein a part or the whole of the core filler comprises a phase changing material (PCM).

131. The element according to claim 118 wherein a part of or the whole of the core filler comprises a substantially non-compressible material selected from the group consisting of polymers, metals, silicates, and silicones, e.g. in the form of a continuous or discontinuous fibre or spheres, selected from glass fibres or spheres, rock wool fibres, carbon fibres, aramide fibres, silicate fibres such as basalt fibres, steel fibres, polyethylene fibres, polypropylene fibres, mineral fibres and any combination thereof comprising at least one of the foregoing materials.

132. The element according to claim 63, wherein a part or the whole of the base material and/or optionally core filler comprises a nano-, micro-, meso- and/or macro-porous material or any combination thereof.

133. The element according to claim 63, wherein a plurality of the cross sectional hole shapes are substantially circular.

134. The element according to claim 63, wherein a plurality of cross sectional hole have shapes selected from s polygon shape, a triangle shape, a quadrilateral shape, s square shape, a rectangular shape or a rhomboid shape.

135. The element according to claim 63, wherein the cross sectional hole shape and/or size of the holes and/or an elongation shape of the holes varies along the element length and/or the first and/or further longitudinal direction.

136. The element according to claim 63, wherein the thermal insulating element is shaped with a cross sectional element profile specifically configured for partially contacting and/or overlapping a part or the whole of another such element e.g. when helically wound onto a pipe.

137. The element according to claim 63, wherein the thermal insulating element has a hole/base material volume ratio in the order of between about 2% to about 98.

138. The element according to claim 63, wherein the thermal insulating element has a hole/base material volume ratio in the order of between about 5% to about 95.

139. The element according to claim 63, wherein the thermal insulating element has a hole/base material volume ratio in the order of between 45% and 93.

140. The element according to claim 63, wherein the thermal insulating element has a hole/base material volume ratio larger than 50%.

141. The element according to claim 63, wherein the thermal insulating element has a hole/base material volume ratio larger than 60%.

142. The element according to claim 63, wherein the thermal insulating element has a hole/base material volume ratio larger than 80%.

143. The element according to claim 63, wherein the thermal insulating element has a hole/base material volume ratio larger than 90%.

144. The element according to claim 63, wherein the thermal insulating element has a hole/base material volume ratio larger than 93%.

145. The element according to claim 63, wherein the thermal insulating element comprises at least one elongated interior hole provided with at least one sensor, such as a fibre optical sensor provided in a through hole.

146. The element according to claim 63, being bonded to or welded to or at least in contact with a further such element along at least one side face and/or end face and/or top or bottom face thereof.

147. An armoured unbonded flexible pipe comprising a thermal insulating layer comprising at least one thermal element according to any of the claims 63.

148. The unbonded flexible pipe according to claim 146, wherein at least one element is wound around the flexible pipe.

149. The unbonded flexible pipe according to claim 147, wherein the element is in the form of an infinite strip wound around the flexible pipe, such as wound helically around the flexible pipe.

150. The unbonded flexible pipe according to claim 147, wherein the element is lying around the flexible pipe with such a lay angle theta that at least said first longitudinal direction of the element coincides with the radial direction of the pipe or alternatively coincides with the lay angle theta.

151. The unbonded flexible pipe according to claim 147 comprising one or more layers of elements.

152. The unbonded flexible pipe according to claim 147, wherein at least two wound elements are in contact, such as overlap, such as interlock each other.

153. A method of manufacturing a thermal insulating element to claim 63, comprising
providing a base material, preferably a resin such as a polymer or a polymeric mixture, preferably an extrudable polymer,
extruding said base material in an element length thereof, and during or after said extrusion providing at least one first series of hole configurations, said first series comprising a plurality of elongated interior holes, each comprising a central hole axis (A) along its elongation that extends substantially mutually in parallel to each other at least along a first longitudinal direction,
wherein each hole in a plane perpendicular to the first general longitudinal direction comprises a cross sectional hole shape, and
wherein the elastic modulus E of said base material at least along said first longitudinal direction is equal to or larger than 1.5 GPa.

154. The method according to claim 152, wherein at least said first longitudinal direction and/or said element length coincides with an extrusion direction during extrusion.

155. The method according to claim 152, further comprising providing the holes during extrusion by stratification on one top surface of said element of a plurality of longitudinally extending grooves, which during or after extrusion are closed again e.g. by rolling on top of said top surface or by providing a further covering layer of base material.

156. The method according to claim 152, further comprising providing said core filler into at least a part of said holes during or after said stratification, such as before, during or after the hole closing, such as after said thermal insulating element has solidified.

157. The method according to claim 152, further comprising providing any through holes and/or connection holes during or after extrusion, such as providing such holes with a hole tool in the not yet solidified polymer matrix or after solidifying, e.g. by drilling.

158. The method of manufacturing an armoured unbonded flexible pipe according to claim 152, comprising laying at least one thermal insulating element around the flexible pipe with such a lay angle theta that at least said first longitudinal direction of the element coincides with the radial direction of the pipe or with the lay angle theta.
